(19) United States
(12) Patent Application Publication
(10) Pub. No.: US 2018/0270517 A1
(43) Pub. Date: Sep. 20, 2018

(54) Decoupled Playback of Media Content Streams

(71) Applicant: Microsoft Technology Licensing, LLC, Redmond, WA (US)

(72) Inventors: Alain Philippe Maillot, Redmond, WA (US); Roy Berger, Seattle, WA (US); Hayden William McAfee, Redmond, WA (US); Robert Disano, Seattle, WA (US); Mikhail Skobov, Redmond, WA (US)

(21) Appl. No.: 15/462,888

(22) Filed: Mar. 19, 2017

(51) Int. Cl. H04N 21/242; H04N 21/234; H04N 21/233; H04N 21/2387

(52) U.S. Cl. CPC H04N 21/242; H04N 21/2387; H04N 21/233; H04N 21/234

(57) ABSTRACT

A technique is described herein for decoupling the playback of media content streams that compose a media item. In one implementation, the technique involves: in a synchronized state, presenting a stream of first media content (such as audio content) in synchronization with a stream of second media content (such as video content); detecting a desynchronization event; in response to the desynchronization event, transitioning from the synchronized state to a desynchronized state by changing (e.g., slowing) a rate at which the stream of second media content is presented, relative to the stream of first media content; detecting a resynchronization-initiation event; and, in response to the resynchronization-initiation event, returning to the synchronized state by providing a compressed presentation of the stream of second media content. The technique further involves presenting the stream of first media content at a given non-zero rate while in the desynchronized state.

### BACKGROUND

A media playback apparatus plays an audiovisual media item such that its video content is synchronized with its audio content. The media playback apparatus may also allow the user to manually adjust the rate at which a media item is presented. Nevertheless, at any given time, this kind of media playback apparatus still presents the video content and the audio content in synchronization.

### SUMMARY

A technique is described herein for decoupling the playback of media content streams that compose a media item. In one implementation, the technique involves: in a synchronized state, presenting a stream of first media content (such as audio content) in synchronization with a stream of second media content (such as video content); detecting a desynchronization event; in response to the desynchronization event, transitioning from the synchronized state to a desynchronized state by changing (e.g., slowing) a rate at which the stream of second media content is presented, relative to the stream of first media content; detecting a resynchronization-initiation event; and, in response to the resynchronization-initiation event, returning to the synchronized state by providing a compressed presentation of the stream of second media content. The compressed presentation is formed based on second media content that was not presented at a same time as corresponding portions of the first media content in the desynchronized state. The technique further involves presenting the stream of first media content at a given non-zero rate while in the desynchronized state.

As used here, the term “compressed presentation” or the like encompasses different ways of presenting a span of media content that was originally intended to take x time units to present (in the normal synchronized state) in y time units, where y<x. For instance, the technique can present a compressed presentation by increasing the rate at which the media content is presented, or by forming an abbreviated digest of the media content, etc.

For example, the technique can involve pausing a stream of video content when it is determined that the user has diverted his or her attention from the presentation of the video content. In the subsequent desynchronized state, the technique continues to play the stream of audio content at a normal playback rate. Upon determining that the user has turned his or her attention back to the video content, the technique involves speeding up the playback of the stream of video content (relative to the rate at which the audio content is presented) until the synchronized state is once again achieved, e.g., either by increasing the rate at which the stream of video content is presented, or by generating and playing a digest of the video content. The accelerated playback of the video content apprises the user of video content that lags behind the audio content that has already been presented. In this example, the diversion of the user's attention constitutes a desynchronization event, while the resumption of the user's attention constitutes a resynchronization-initiation event.

The above technique can be manifested in various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an overview of a computing device for desynchronizing the playback of a stream of audio content (an “audio stream”) and a stream of video content (a “video stream”), upon detecting a desynchronization event.

FIG. 2 shows a trigger component that is used to detect trigger events, such as a desynchronization event and a resynchronization-initiation event.

FIG. 3 shows one implementation of a deceleration behavior determination component (DBDC) and a resumption behavior determination component (RBDC), which are two components of the computing device of FIG. 1.

FIG. 4 shows functions that can be applied by the DBDC and the RBDC of FIG. 3 to respectively decelerate and accelerate the playback of a video stream.

FIG. 5 shows another implementation of an RBDC that can be used in the computing device of FIG. 1.

FIG. 6 shows an example of the operation of the RBDC of FIG. 5.

FIG. 7 shows another implementation of an RBDC that can be used in the computing device of FIG. 1.

FIG. 8 shows an example of the operation of the RBDC of FIG. 7.

FIG. 9 shows one implementation of functionality for forming a digest, in the context of the RBDC of FIG. 7.

FIG. 10 shows another implementation of functionality for forming a digest, in the context of the RBDC of FIG. 7.

FIG. 11 shows an overview of a computing device for desynchronizing the playback of a stream of first media content and a stream of second media content, upon detecting a desynchronization event. The computing device of FIG. 11 represents a more general counterpart to the computing device of FIG. 1.

FIG. 12 shows a process that represents one manner of operation of the computing device of FIG. 1.

FIG. 13 shows a process that represents one manner of operation of the computing device of FIG. 11.

FIG. 14 shows a process that represents one manner of operation of the RBDC of FIG. 5.

FIG. 15 shows a process that represents one manner of operation of the RBDC of FIG. 7.

FIG. 16 shows illustrative computing functionality that can be used to implement any aspect of the features shown in the foregoing drawings.

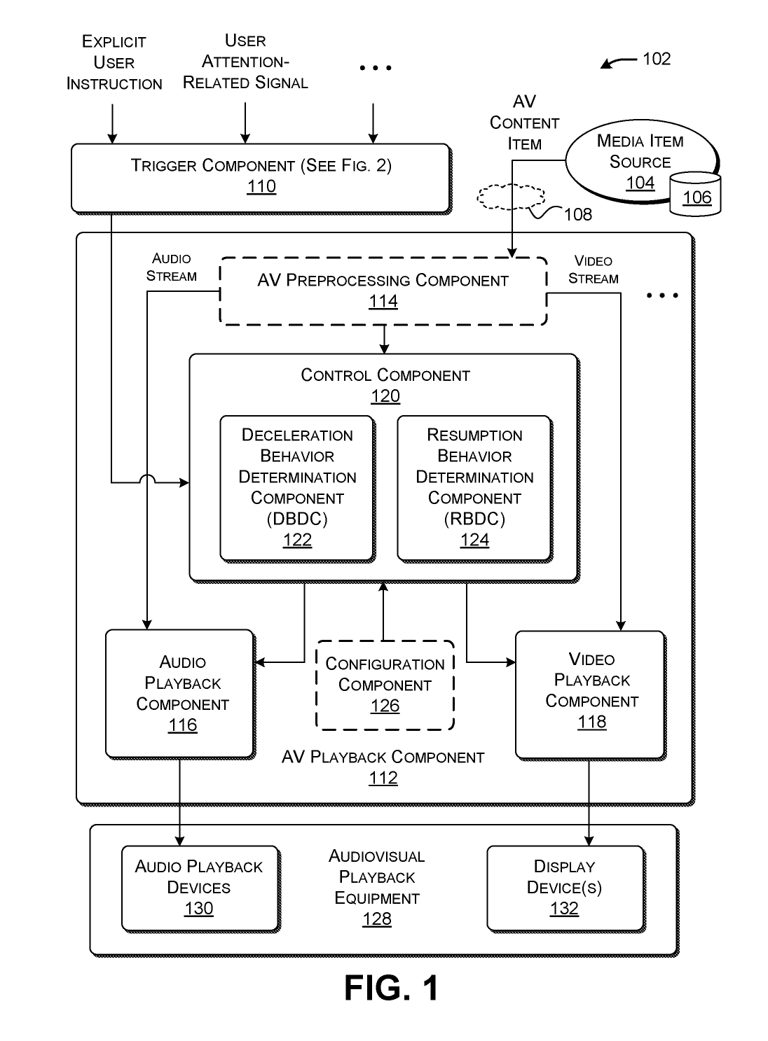

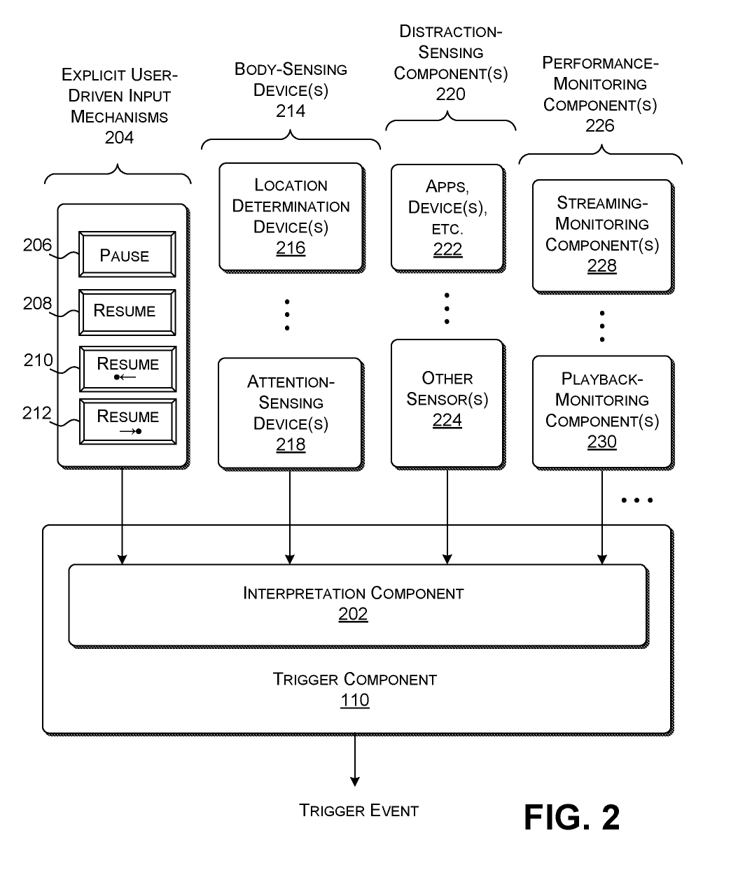

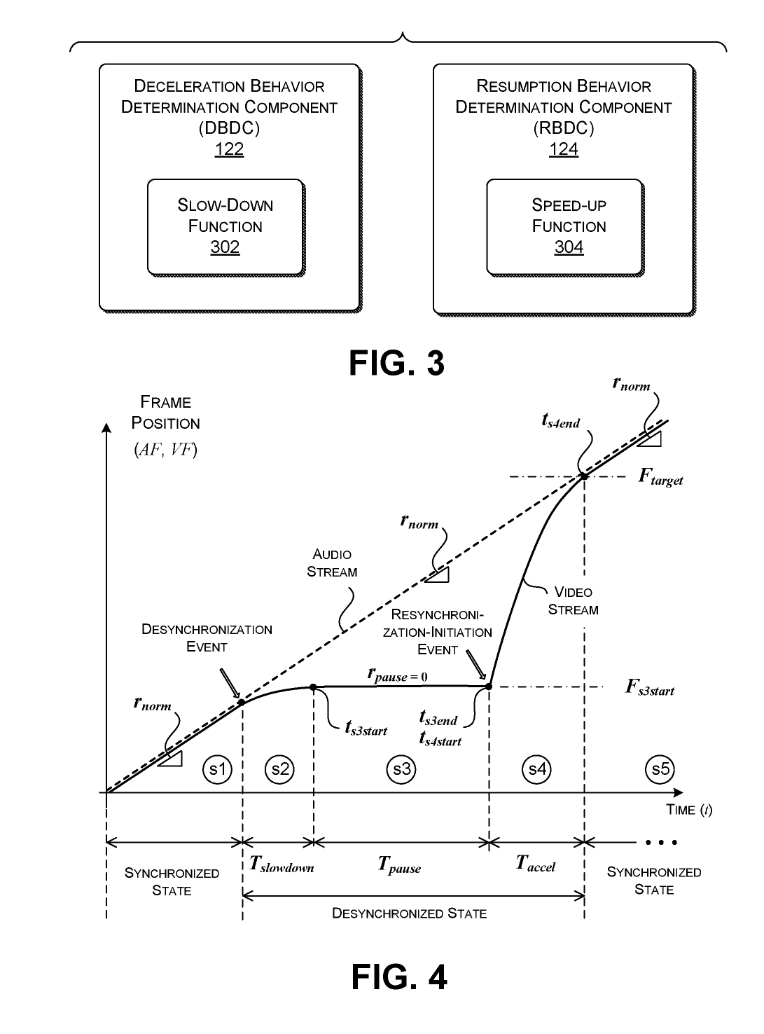

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes a computing device having functionality for presenting streams of media content in a decoupled manner. Section B sets forth an illustrative method which explains the operation of the computing device of Section A. And Section C describes illustrative computing functionality that can be used to implement any aspect of the features described in Sections A and B.

As a preliminary matter, some of the figures describe concepts in the context of one or more structural components, also referred to as functionality, modules, features, elements, etc. In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component. Section C provides additional details regarding one illustrative physical implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). In one implementation, at least some of the blocks shown in the flowcharts can be implemented by software running on computer equipment, or other logic hardware (e.g., FPGAs), etc., or any combination thereof.

As to terminology, the phrase “configured to” encompasses various physical and tangible mechanisms for performing an identified operation. The mechanisms can be configured to perform an operation using, for instance, software running on computer equipment, or other logic hardware (e.g., FPGAs), etc., or any combination thereof.

The term “logic” encompasses various physical and tangible mechanisms for performing a task. For instance, each operation illustrated in the flowcharts corresponds to a logic component for performing that operation. An operation can be performed using, for instance, software running on computer equipment, or other logic hardware (e.g., FPGAs), etc., or any combination thereof. When implemented by computing equipment, a logic component represents an electrical component that is a physical part of the computing system, in whatever manner implemented.

Any of the storage resources described herein, or any combination of the storage resources, may be regarded as a computer-readable medium. In many cases, a computer-readable medium represents some form of physical and tangible entity. The term computer-readable medium also encompasses propagated signals, e.g., transmitted or received via a physical conduit and/or air or other wireless medium, etc. However, the specific terms “computer-readable storage medium” and “computer-readable storage medium device” expressly exclude propagated signals per se, while including all other forms of computer-readable media.

The following explanation may identify one or more features as “optional.” This type of statement is not to be interpreted as an exhaustive indication of features that may be considered optional; that is, other features can be considered as optional, although not explicitly identified in the text. Further, any description of a single entity is not intended to preclude the use of plural such entities; similarly, a description of plural entities is not intended to preclude the use of a single entity. Further, while the description may explain certain features as alternative ways of carrying out identified functions or implementing identified mechanisms, the features can also be combined together in any combination. Finally, the terms “exemplary” or “illustrative” refer to one implementation among potentially many implementations.

A. Illustrative System

A.1. Decoupled Playback of Audio Content and Video Content

FIG. 1 shows an overview of a computing device 102 for playing a media item composed of at least a stream of audio content (referred to herein as an “audio stream”) and a stream of video content (referred to herein as a “video stream”). The computing device 102 may correspond to any computing equipment. For instance, the computing device 102 may correspond to a stationary workstation device, a laptop computing device, a set-top box, a game console, any handheld computing device (such as a tablet-type device, a smartphone, etc.), a wearable computing device, an augmented reality or virtual reality device, or any combination thereof. In one case, the computing device 102 can provide all of its components at a single location, e.g., within a single housing. In another case, the computing device 102 may distribute its components over two or more locations.

By way of overview, in a synchronized state, the computing device 102 presents both an audio stream and a video stream at a specified normal playback rate rₙₒᵣₘ. In this state, the computing device 102 displays each portion of the audio stream at the same time as a corresponding portion of the video stream, e.g., such that sounds in the audio stream match corresponding visual content depicted in the video stream. The computing device 102 can advance to a desynchronized state upon receiving a desynchronization event (to be described below). In the desynchronized state, the computing device 102 slows the video stream relative to the audio stream. For instance, the computing device 102 can slow the stream of video content until the video rate equals zero, while continuing to play the audio stream at the normal playback rate rₙₒᵣₘ. Then, upon receiving a resynchronization-initiation event, the computing device 102 returns to the synchronized state by providing a compressed playback of the stream of video content.

As used here, the term “compressed playback” or “compressed presentation” (or the like) encompasses different ways of presenting a span of video that was originally intended to take x time units to display (in the normal synchronized state) in y time units, where y<x. For instance, the computing device 102 can present a compressed presentation by increasing the rate at which the video content is presented (relative to rₙₒᵣₘ), or by forming an abbreviated digest of the video content, etc.

For instance, assume that the user is watching a movie on the computing device 102. Then assume the computing device 102 detects that the user has begun to actively interact with another application (besides the movie playback application). That other application may be hosted by the computing device 102 or another computing device. The computing device 102 interprets this action as a desynchronization event. In response, the computing device 102 will pause the video stream associated with the movie, while continuing to play the audio stream at the normal playback rate rₙₒᵣₘ. Next assume that the user closes the other application or otherwise stops interacting with that application. The computing device 102 interprets this action as a resynchronization-initiation event. In response, the computing device 102 can speed up the playback of the video stream (while again continuing to play the audio stream at the rate rₙₒᵣₘ), until the audio stream is again synchronized with the video stream.

The above scenario is based on the assumption that the user remains free to consume the audio content while interacting with the other application, but cannot effectively perform the dual tasks of watching the video content and interacting with the other application at the same time. (Note: This is not necessarily true in all cases, as will be explained at a later juncture of this explanation.) When the user ceases interaction with the other application, the computing device 102 provides the user with a compressed version of the video content that he or she missed while the computing device 102 was operating in the desynchronized state.

Overall, the computing device 102 offers good user experience and facilitates the efficient consumption of a media item. For instance, the computing device 102 eliminates the need for the user to manually “rewind” the media item to that juncture at which the user first became distracted. This behavior reduces the burden on the user, and also reduces the amount of time that is required to consume the media item (e.g., by eliminating the time spent in replaying portions of the stream of media content).

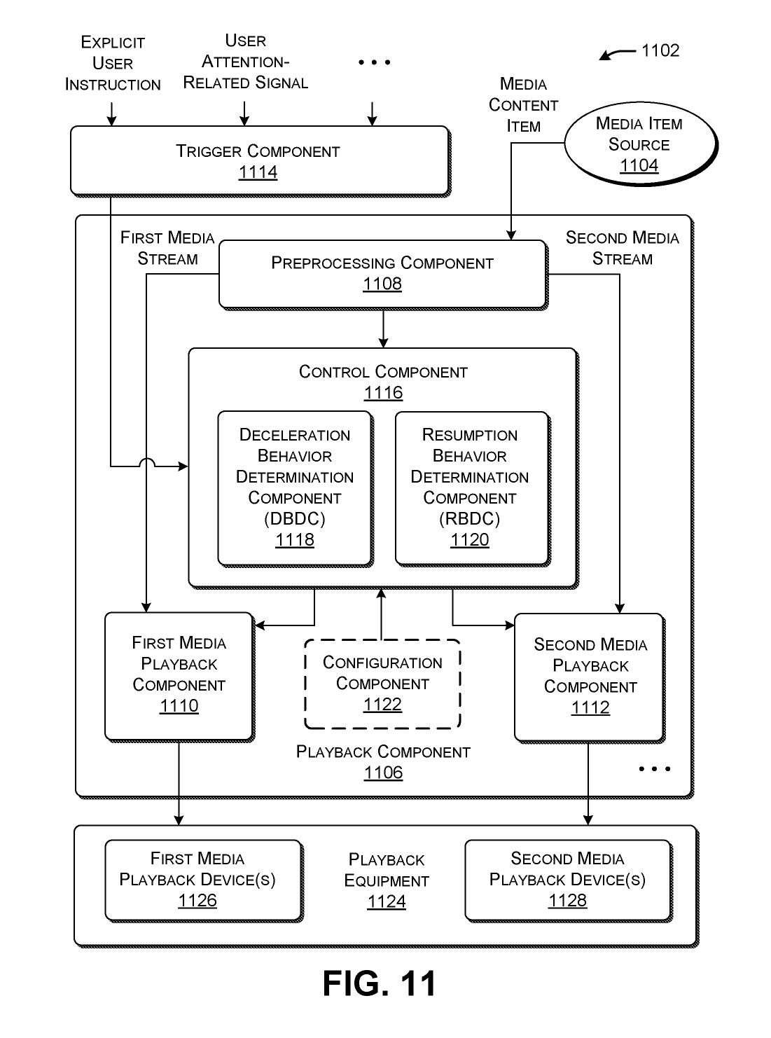

To facilitate understanding of the technology described herein, this subsection (Subsection A.1) will provide details regarding the above-summarized manner of operation, with respect to one particular case in which the media item is composed of an audio stream and a video stream, and in the case in which the video stream is suspended while the audio stream continues to play. Note, however, that this example represents just one non-limiting case among many. For instance, the next subsection (Subsection A.2) will extend the principles established in Subsection A.1 to the case in which any stream of first media content is decoupled from (and subsequently resynchronized with) any stream of second media content. Subsection A.2 also describes other variations to the implementation of Subsection A.1. In other words, the computing device described in Subsection A.2 (and specifically shown in FIG. 11) represents a more general counterpart to the computing device 102 of FIG. 1.

FIG. 1 will be generally described in top-to-bottom fashion. The computing device 102 receives a media item from any media item source 104. For instance, the media item may correspond to a movie having video content and audio content. The media item can also include other types of content, such as close-caption text data, an audio explanation track (for use by the visually impaired), etc.

The media item source 104 may correspond to a local data store and/or a remote data store (generically denoted in FIG. 1 as data store 106). In the scenario in which the media item is remotely located from the computing device 102, the computing device 102 can obtain the media item via a computer network 108 of any type, such as a local area network, a wide area network (e.g., the Internet), a point-to-point link, etc., or any combination thereof. The computer network 108 can include any combination of hardwired links, wireless links, routers, etc., governed by any protocol or combination of protocols.

The computing device 102 can obtain the media item from the media item source 104 using any approach. For instance, the computing device 102 can download the media item from the media item source 104, store the media item in a local data store, and then play the media item from that local data store. Or the computing device 102 can stream the media item from the media item source 104 while simultaneously playing it.

In one implementation, the media item can be expressed using a container file that conforms to any environment-specific file container format. The container file describes and encapsulates the contents of the media item. The contents may include metadata, a stream of audio content, a stream of video content, and/or any other type(s) of content. Illustrative container formats include MP4 (MPEG-4 Part 14), Audio Video Interleaved (AVI), QuickTime File Format (QTFF), Flash Video (FV), etc. The media item can express its audio content and the video content using any respective coding formats. The audio coding format, for instance, can correspond to MP3, Advanced Audio Coding (AAC), etc. The video coding format can correspond to H.264 (MPEG-4 Part 10), VP9, etc.

More generally, an audio stream contains a sequence of audio portions (e.g., audio frames), while a video stream contains a sequence of video portions (e.g., video frames). The media item also associates timing information with its streams. In some implementations (e.g., with respect to MPEG-related formats), the timing information can take the form of presentation timestamps. The timing information specifies the timing at which the computing device 102 presents the audio portions and the video portions in its streams, with reference to a specified reference time clock. In the normal synchronized state, the computing device 102 leverages the timing information to provide a synchronized playback of the audio content and video content.

A trigger component 110 determines when a trigger event has occurred, corresponding to either a desynchronization event or a resynchronization-initiation event. As noted above, a desynchronization event prompts the computing device 102 to transition from a synchronized state to a desynchronized state. A resynchronization-initiation event prompts the computing device 102 to return to the synchronized state over a span of time.

The trigger component 110 can interpret different kinds of occurrences as a desynchronization event. Generally, the trigger component 110 will interpret an occurrence as a desynchronization event when the occurrence constitutes evidence that the user who is operating the computing device 102 will no longer be able to give a requisite degree of attention to the video stream that is currently playing; that conclusion, in turn, is based on an environment-specific rule which maps the occurrence to the presumed impact of the occurrence on the attention of the user. In other words, that rule implicitly or explicitly defines what constitutes a “requisite degree of attention.” For example, as in the case above, the trigger component 110 will interpret an indication that the user has begun interacting with another application as an indication that the user is no longer paying full attention to the video stream playing on the computing device 102.

Likewise, the trigger component 110 can interpret different kinds of occurrences as a resynchronization-initiation event. Generally, the trigger component 110 will interpret an occurrence as a resynchronization-initiation event when that occurrence constitutes evidence that the user is now able to resume consumption of the stream of video content with the requisite degree of attention; that conclusion, in turn, is again based on an environment-specific rule which maps the occurrence to the presumed impact of the occurrence on the attention of the user.

FIG. 2, to be described below, provides further details regarding one implementation of the trigger component 110. FIG. 2 also provides further details regarding the nature of different occurrences that the trigger component 110 may interpret as desynchronization events and resynchronization-initiation events, with respect to environment-specific rules.

An audiovisual (AV) playback component 112 plays the media item. To perform this task, the AV playback component 112 can include an AV preprocessing component 114 that performs any environment-specific processing on the audio stream and/or the video stream. For instance, with respect to some file formats, the AV preprocessing component 114 can demultiplex a stream of media content to produce the audio stream and the video stream. The AV preprocessing component 114 can also perform various preliminary operations on each stream, including decompression, error correction, etc. The AV preprocessing component 114 uses appropriate codecs to perform these operations, depending on the coding format used to encode the audio content and the video content. The AV playback component 112 also includes an audio playback component 116 for controlling the final playback of the audio stream, and a video playback component 118 for controlling the final playback of the video stream.

Although not specifically shown in FIG. 1, the media item can optionally include additional media components, that is, in addition to an audio stream and a video stream. In that case, the AV preprocessing component 114 can include additional codecs for processing those media streams, and the AV playback component 112 can include additional playback components for controlling the final playback of those media streams.

A control component 120 controls the manner in which the AV playback component 112 presents the media item. The control component 120 acts on instructions from a user to play the media item, pause the media item, etc. In the absence of a desynchronization event, the control component 120 controls the audio playback component 116 and the video playback component 118 such that the audio stream is presented in synchronization with the video stream, and such that both streams are presented at the normal playback rate, rₙₒᵣₘ. In other words, this behavior represents a normal playback mode.

In addition, the control component 120 controls the manner in which the video playback component 118 plays the video stream relative to the audio stream upon the occurrence of a desynchronization event. For instance, upon receiving a desynchronization event, a deceleration behavior determination component (DBDC) 122 controls the manner in which the video stream is slowed from the normal playback rate rₙₒᵣₘ (associated with the synchronized state) to a video pause rate (rₚₐᵤₛₑ), where, in some cases, rₚₐᵤₛₑ=0. Upon receiving a resynchronization-initiation event, a resumption behavior determination component (RBDC) 124 controls the manner in which the video stream is sped up from the video pause rate rₚₐᵤₛₑ back to the normal playback rate rₙₒᵣₘ, until the synchronized state is again reached. Throughout the above-summarized video desynchronization/resynchronization process, the control component 120 continues to control the audio playback component 116 to play the audio stream at the normal playback rate, rₙₒᵣₘ.

In one implementation, the control component 120 controls the video playback component 118 by sending control instructions to the video playback component 118. Each instruction commands the video playback component 118 to present a specified video frame at a particular time t. Over the course of slowing the video stream down, the control component 120 will send instructions to the video playback component 118 that specify video frame positions that increasingly fall behind corresponding audio frame positions. Over the course of resynchronizing the video stream, the control component 120 will send instructions to the video playback component 118 that specify video frame positions that increasingly catch up to corresponding audio frame positions. In another implementation (described below), the control component 120 can send a temporally partitioned version of the video stream (having plural component streams) to the video playback component 118, and instruct the video playback component 118 to simultaneously play the component streams at a prescribed playback rate. In another implementation (described below), the control component 120 can send a digest to the video playback component 118, and instruct the video playback component 118 to play the digest at a prescribed playback rate.

At any time in the desynchronized state, the audio playback component 116 and the video playback component 118 no longer present audio portions and video portions in synchronization with each other. This means that, during this state, the audio content is decoupled from the video content. This further means that the time information embedded in the media item no longer dictates the manner in which the audio content is presented relative to the video content.

The video playback component 118 can carry out instructions sent by the control component 120 in different ways. In one implementation, the video playback component 118 buffers the video stream provided by the AV preprocessing component 114, and plays the video stream back at a timing specified by the control component 120. In another implementation, the video playback component 118 receives plural component streams and/or a digest from the control component 120, and plays that video information at a rate specified by the control component 120.

A configuration component 126 allows a user to control any aspect of the behavior of the control component 120. For example, the configuration component 126 can allow the user to specify the manner in which the RBDC 124 speeds up the video stream. For instance, the configuration component 126 allows the user to specify a resumption technique that will be used to provide a compressed video stream. The configuration component 126 can also allow the user to specify a time span (T_{accel}) over which the compressed video stream is presented.

Audiovisual playback equipment 128 plays the streams of media content provided by the AV playback component 112. For instance, the audiovisual playback equipment 128 includes one or more audio playback devices 130 (e.g., speakers) for presenting the audio content, and one or more display devices 132 for visually presenting the video content. The display device(s) 132, for instance, can include a liquid crystal display (LCD) device, a projection mechanism, an augmented reality playback device, a fully immersive virtual reality device, etc.

FIG. 2 shows one implementation of the trigger component 110 of FIG. 1. As noted above, the trigger component 110 determines when an occurrence corresponds to either a desynchronization event or a resynchronization-initiation event. The trigger component 110 relies on an interpretation component 202 to perform its analysis based on one or more input signals received from one or more signal-supplying components, with reference to an environment-specific set of rules. The rules may be embodied as a set of discrete IF-THEN-type rules in a data store (and which may be embodied in a mapping lookup table), and/or an algorithm, and/or by weights of a machine-learned model, etc. For example, an illustrative discrete IF-THEN rule or machine-trained binary classifier can map one or more input signals (having respective input signal values) into a conclusion as to whether or not a particular triggering event has occurred.

As shown in FIG. 2, the signal-supplying components can be grouped into different categories depending on the kinds of evidence they provide as to occasions and/or conditions that merit the suspension or the subsequent resumption of the video stream. For example, many of the signal-supplying components provide evidence as to the ability of the user to pay attention to the video stream. Other signal-supplying components provide evidence of conditions that have a bearing on the ability of the AV playback component 112 to play the video stream, independent of the user's ability to pay attention to the video stream.

As a first category, one or more user-driven input mechanisms 204 allow a user to manually specify the manner in which a video stream is paused and subsequently resumed. Actuation of such a mechanism generates an input signal that is fed to the trigger component 110. For instance, the mechanism(s) 204 can include one or more graphical control elements displayed on a graphical user interface presentation. The user may interact with such a graphical control element via a touch-sensitive surface or through some other input mechanism. Alternatively, or in addition, the mechanism(s) 204 can include one or more physical control elements (e.g., physical buttons) provided by the computing device 102.

In one implementation, a user may actuate a pause control 206 to instruct the trigger component 110 to pause the video stream. The interpretation component 202 interprets the resultant input signal as a desynchronization event, which, in turn, prompts the DBDC 122 to invoke the video slow-down behavior. The user may subsequently activate a resume control 208 to resume the video stream. The interpretation component 202 interprets the resultant input signal as a resynchronization-initiation event, which, in turn, prompts the RBDC 124 to invoke the video speed-up behavior.

In other cases, instead of the resume control 208, a user may invoke a resume-rewind control 210. The interpretation component 202 interprets the resultant input signal as an instruction to resume the synchronization state at the juncture at which the desynchronization event was received. This behavior effectively rewinds the media item to the frame position at which the desynchronization event was received, upon which the AV playback component 112 plays the audio stream and the video stream at the normal playback rate Also note that this behavior omits the accelerated playback of the video stream described above. The user may invoke this operation when he or she desires to watch an unmodified version of the video stream, rather than a compressed version thereof.

In other cases, a user may invoke a resume-forward control 212 instead of the normal resume control 208. The interpretation component 202 interprets the resultant input signal as an instruction to resume the synchronization state at the juncture in the media item corresponding to the current frame position of the audio stream. To perform this operation, the AV playback component 112 advances the video stream to the same frame position as the current frame position of the audio stream. Like the case of the resume-rewind operation, this behavior omits the accelerated playback of the video stream. The user may invoke this operation when he or she is not interested in viewing the video content that has been omitted during the desynchronization state.

One or more user body-sensing devices 214 detect the user's bodily movements in relation to the display device(s) 132. For instance, one or more location determination devices 216 can determine the proximity of the user to the display device(s) 132. The location determination device(s) 216 can use any technique(s) to determine the location of the user, including any of: a global positioning system (GPS) technique, a beacon-sensing technique, a signal triangulation technique, a near field communication (NFC) technique, etc. Alternatively, or in addition, the location determination device(s) 216 can determine the location of the user using any type of inertial measurement unit carried by the user that measures the motion of the user, e.g., using an accelerometer, gyroscope, magnetometer, etc. Alternatively, or in addition, the location determination device(s) 216 can detect the user's presence using one or more video cameras. Alternatively, or in addition, the location determination device(s) 216 can detect the user's presence using one or more depth camera systems (which may use a time-of-flight technique, a structured light technique, a stereoscopic technique, etc.). Alternatively, or in addition, the location determination device(s) 216 can detect the user's presence using any type of room occupancy sensor, and so on. Illustrative types of occupancy sensors include weight sensors (e.g., which may be embedded in the floor), laser beam-type sensors, infrared radiation sensors, etc.

The interpretation component 202 receives at least one input signal from the location determination device(s) 216 that reflects the current location of the user. That input signal may describe the absolute location of the user, or the location of the user relative to the display device(s) 132. Based on this information, the interpretation component 202 can assess whether the user has diverted his or her attention from the display device(s) 132 by determining whether the user is more than a prescribed threshold distance from the known location of the display device(s) 132. The interpretation component 202 can determine that the user has turned his or her attention back to the display device(s) 132 when the user once again moves within the threshold distance to the display device(s) 132.

One or more attention-sensing devices 218 detect the presumed focus of attention of the user. For example, the attention-sensing device(s) 218 can include one or more cameras for capturing information having a bearing on the gaze of the user. The interpretation component 202 can use known techniques for determining the gaze based on the captured information. For instance, the interpretation component 202 can cast a ray based on the current orientation of the user's head and/or the user's eyes. The interpretation component 202 can determine that the user has diverted his or her attention from the display device(s) 132 when the ray cast by the user's focus of attention does not intersect the display device(s) 132. The interpretation component 202 can determine that the user has turned his or her attention back to the display device(s) 132 when the ray cast by the user's focus of attention moves back to the display device(s) 132.

In another example, a depth camera system, such as the KINECT system provided by MICROSOFT COPORATION of Redmond, Washington, can determine the posture and/or movement of the user at any given time. The interpretation component 202 can determine that the user has diverted his or her attention by comparing image information captured by the depth camera system with pre-stored patterns. Each such pattern corresponds to a posture and/or movement that is indicative of the fact that the user is not paying attention to the display device(s) 132. The interpretation component 202 can determine that the user has directed his or her attention back to the display device(s) 132 in a complementary manner to that described above, e.g., by making reference to pre-stored patterns.

One or more distraction-sensing components 220 determine whether the user is engaged in an activity that may divert the user's attention from the display device(s) 132. The distraction-sensing component(s) 220 include applications and/or user devices 222 associated with or otherwise controlled by the user. Such an application or user device can send activity information to the interpretation component 202 when the user interacts with it. The activity information constitutes evidence that the user is interacting with the application or user device. The interpretation component 202 can conclude that the user has directed his or her attention away from the display device(s) 132 when the user's level of interaction with another application or user device rises above some environment-specific threshold of engagement, as specified by an environment-specific rule. The interpretation component 202 can conclude that the user has resumed engagement with the display device(s) 132 when the level of interaction with the application or user device falls below the threshold level of engagement. The interpretation component 202 has knowledge of what applications and user devices are associated with the user based on predetermined registration information; that registration information links the applications and user devices to the user. For instance, all such applications and user devices may be associated with the same user account.

One or more other sensors 224 provide additional evidence of other occurrences that may constitute specific distractions, or the subsequent removal of those distractions. One such sensor detects when an incoming telephone call has been received. Another sensor may detect when a door bell or other environmental alert signal has been received. Another sensor may detect the user's verbal engagement with another user, and so on. The sensors 224 can include microphones, cameras of any type(s), etc. The interpretation component 202 can determine whether an input signal provided by any of these sensors 224 constitutes a desynchronization event (or a resynchronization-initiation event) by making reference to a store of environment-specific rules. For instance, the interpretation component 202 can interpret an incoming telephone call as a desynchronization event, and the user's ending of the call as a synchronization-initiation event.

Finally, one or more optional performance-monitoring components 226 can determine some condition that affects the playback of the media item. For instance, one or more streaming-monitoring components 228 can determine whether the rate at which the video stream is received over the computer network 108 has fallen below a prescribed rate due to network bandwidth-related issues (e.g., reflecting congestion in the network 108), network connectivity-related issues, and/or other factors. Alternatively, or in addition, one or more playback-monitoring components 230 determine whether the rate at which the video stream is being played has fallen below a prescribed rate due to some performance-related issue associated with the computing device 102 itself. The interpretation component 202 can interpret any of the above-described congestion conditions as a desynchronization event. The interpretation component 202 can interpret the subsequent alleviation of a congestion condition as a resynchronization-initiation event. The computing device 102 can respond these trigger events in the above-described manner, presuming that the computing device 102 is able to present audio information at the normal playback rate while the video content is halted.

The above-indicated mapping of input signals to trigger events is provided by way of example, not limitation. Other implementations can provide other rules that map input signals to desynchronization and resynchronization-initiation events.

FIG. 3 shows one implementation of the deceleration behavior determination component (DBDC) 122 and the resumption behavior determination component (RBDC) 124, introduced above. The DBDC 122 governs the manner in which the computing device 102 slows down the video stream upon receiving a desynchronization event. The RBDC 124 governs the manner in which the computing device 102 speeds up the video stream upon receiving a resynchronization-initiation event until the synchronized state is again achieved.

In the example of FIG. 3, the DBDC 122 slows the video stream relative to the audio stream by applying a slow-down function 302. The RBDC 124 speeds up the video stream relative to the audio stream by applying a speed-up function 304. Each function can correspond to any mathematical equation(s), algorithm(s) and/or rule(s) for identifying a video frame position (VF) of the video stream to be presented, as a function of time (t). A mathematical equation to decrease or increase the video rate can take any form. For instance, the mathematical equation can include a linear component, a polynomial component, an exponential component, etc. or any combination thereof. Alternatively, or in addition, a function can decrease the video rate in one or more discrete “staircase” steps.

FIG. 4 shows a graphical representation of one overall function that the control component 120 uses to control the playback of the video stream over five regions or sections, labeled s1, s2, s3, s4, and s5. The slow-down function 302 particularly governs the playback of the video stream in Section s2, while the speed-up function 304 particularly governs the playback in Section s4.

In all sections (s1-s5), the control component 120 instructs the audio playback component 116 to play the audio stream at the normal playback rate, rₙₒᵣₘ. As such, at any given time t, the audio playback component 116 will present an audio frame at an audio frame position (AF) given by: AF=rₙₒᵣₘ*t.

Section s1 corresponds to a synchronized state in which the control component 120 controls the video playback component 118 so as to present the video stream at the normal playback rate, rₙₒᵣₘ. At such, at any given time t, the video playback component 118 will present a video frame at a video frame position (VF) given by VF=rₙₒᵣₘ*t. In this state, the control component 120 controls the audio playback component 116 and the video playback component 118 to respectively present audio frames and video frames at the same frame positions.

Section s2 begins when the trigger component 110 detects a desynchronization event. Thereupon, the DBDC 122 applies its slow-down function 302 to slow the video stream relative to the audio stream. In one merely illustrative case, the slow-down function 302 can compute the current video frame position (VF) as a function of time (t) according to the following equation:

$$V F = {r}_{norm} * t - ( \frac{{r}_{norm}}{{T}_{slowdown}} ) * {t}^{2} . \qquad ( 1 )$$

In this equation, T_{slowdown} refers to an environment-specific length of the slowdown period. In one environment, T_{slowdown} corresponds to a fixed value set in advance. For instance, in one case, T_{sowdown}=4000 ms. At the end of the Section s2, the video rate equals a video pause rate (rₚₐᵤₛₑ). Here, rₚₐᵤₛₑ=0, but in other cases, the video pause rate can be any non-zero constant rate.

In another implementation, the slow-down function 302 can abruptly change the video rate from rₙₒᵣₘ to the video pause rate rₚₐᵤₛₑ, e.g., in a single discrete step. In another implementation, the slow-down function 302 can slow down the video stream using a linear function until the target video pause rate is achieved. Still other types of slow-down functions are possible.

Section s3 begins at the end of the slow-down period and ends at the time at which a resynchronization-initiation event is received. In one implementation, the control component 120 controls the video playback component 118 to present the video stream at the video pause rate rₚₐᵤₛₑ throughout the span of Section s3. Here, because rₚₐᵤₛₑ=0, the video playback component 118 pauses the video stream at the video frame that was displayed at the end of Section s2.

Section s4 begins when the trigger component 110 detects a resynchronization-initiation event. Thereupon, the RBDC 124 applies its speed-up function 304 to speed up the video stream relative to the audio stream until the synchronized state is again achieved. In one illustrative case, the speed-up function 304 first computes a target frame number (F_{target}). That target frame number corresponds to the video frame position that should be presented at the end of Section s4. In one implementation, the speed-up function 304 can compute the target frame number as: F_{target}=(tₛ₄ₛₜₐᵣₜ+T_{accel})*rₙₒᵣₘ. Here, tₛ₄ₛₜₐᵣₜ corresponds to the time value at the start of Section s4. T_{accel} refers to the temporal length of Section s4, corresponding to the amount of time that the speed-up function 304 is applied.

Different implementations can compute T_{accel} in different respective ways. In one approach, the speed-up function 304 specifies a fixed value for T_{accel}, such as, without limitation, 10000 ms. In another implementation, the speed-up function 304 computes T_{accel} as a function of the temporal length of Section s3. For instance, the speed-up function 304 can compute T_{accel} as c₁+c₂*(tₛ₄ₛₜₐᵣₜ−tₛ₃ₛₜₐᵣₜ). As noted above, tₛ₄ₛₜₐᵣₜ refers to the time at the start of the Section s4. tₛ₃ₛₜₐᵣₜ refers to the time at the start of Section s3. c₁ and c₂ correspond to environment-specific constant values.

The speed-up function 304 can next compute a slope value m based on the following equation:

$$m = - \frac{( ( {F}_{target} - {F}_{s 3 start} ) - {T}_{accel} * {r}_{norm} )}{{T}_{accel}^{2}} . \qquad ( 2 )$$

In this equation, Fₛ₃ₛₜₐᵣₜ refers to the video frame position at the start of Section s3.

Finally, the speed-up function 304 can compute the video frame position (VP) using the following equation:

VF=VFₛ₄ₛₜₐᵣₜ+1/2*m*t²+rₙₒᵣₘ*t−T_{accel}*m*t (3).

In this equation, VFₛ₄ₛₜₐᵣₜ refers to the video frame position at the start of Section s4.

At the termination of Section s4, the video content will have “caught up” with the audio content. The video content and audio content remain in synchronization in Section s5. More specifically, in Section s5, the computing AV playback component 112 plays the audio content and the video content using the same equations set forth above with respect to Section sl.

Other implementations can use other types of speed-up functions to achieve resynchronization of the audio stream and the video stream. For example, in another case, a speed-up function 304 can apply a first sub-function to gradually increase the video rate from rₚₐᵤₛₑ (the rate at the beginning of Section s4) to some constant rate r_{rapid}, where r_{rapid}>rₙₒᵣₘ. A second sub-function can maintain the rate at r_{rapid} for a prescribed span of time. A third sub-function can then gradually change the video rate from r_{rapid} to rₙₒᵣₘ.

More generally, the speed-up function 304 can apply any non-linear smoothing operation within at least a part of the temporal span of Section s4, so as to gradually change the video rate. FIG. 4 shows the case in which the RBDC 124 applies a smoothing operation at the end of the Section s4, but not at the beginning of Section s4. But another implementation can also provide a smoothing operation at the beginning of Section s4.

In yet another example, the speed-up function 304 does not calculate T_{accel} in advance (corresponding to the temporal span of Section s4). Rather, the speed-up function 304 can play the video stream at a constant video rate r_{rapid} that is greater than rₙₒᵣₘ. Or the speed-up function 304 can apply any other function to speed up the video stream. The RBDC 124 determines that the Section s4 is complete when the video frame position equals the current audio frame position.

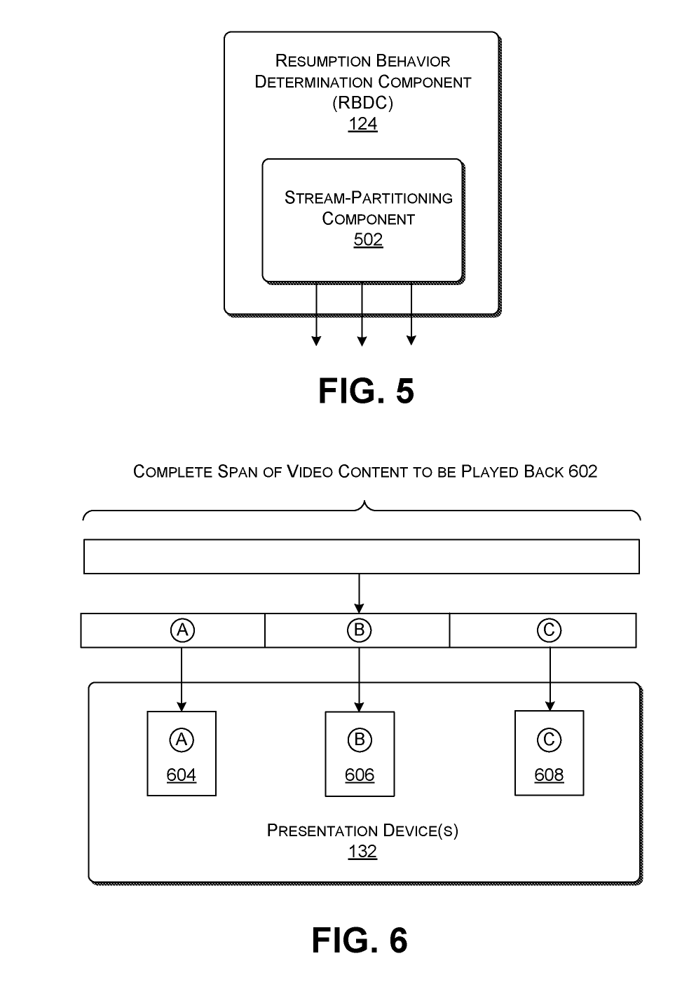

FIG. 5 shows another implementation of the RBDC 124. The stream-partitioning component produces the compressed presentation by temporally partitioning an original video stream up into plural temporally-consecutive component streams, instead of, or in addition to, changing the rate of the original video stream. More specifically, the stream-partitioning component 502 first identifies the amount of time T_{accel} over which the speed-up operation is performed. For instance, the stream-partitioning component 502 can apply a fixed value for T_{accel}. Or the stream-partitioning component 502 can compute the value T_{accel} as a function of the temporal length of Section s3, e.g., in the manner described above. The stream-partitioning component 502 can then identify the entire span of video content N_{Ftotal} to be presented in T_{accel}. This span of video content begins with the video frame position Fₛ₃ₛₜₐᵣₜ at the start of Section s3, and ends with the target frame position F_{target} at the end of Section s4.

The stream-partitioning component 502 can then divide the entire span of video content N_{Ftotal} into any number (f) of equal-sized video segments, each corresponding to a temporal sub-span of the entire span of video content. Finally, the stream-partitioning component 502 instructs the video playback component 118 to simultaneously present f video streams associated with the f video segments. The stream-partitioning component 502 can instruct the video playback component 118 to display each video segment at a video rate equal to N_{Ftotal}/(f*T_{accel}).

Other implementations can vary the above-described behavior in any way. For example, another implementation can break the entire span of video content into unequal sized segments. Alternatively, or in addition, other implementations can play the video segments back at different video rates. Alternatively, or in addition, other implementations can determine the number f of segments based on the value of N_{Ftotal}, e.g., by requiring that no video segment have a duration longer than a specified maximum duration.

FIG. 6 shows an example of the operation of the RBDC 124 of FIG. 5. In this case, the stream-partitioning component 502 breaks an entire span of video content 602 into three temporally consecutive segments labeled A, B, and C. That is, the first video frame of segment B follows the last video frame of segment A, and the first video frame of segment C follows the last video frame of segment B. The video playback component 118 provides three corresponding video streams (A, B, C) to the display device(s) 132.

The display device(s) 132 includes three regions (604, 606, 608) for displaying the three respective video streams. The regions (604, 606, 608) may correspond to discrete regions on a user interface presentation provided by a single display device. Alternatively, or in addition, the AV playback component 112 can display at least two regions on two different display devices.

The configuration component 126 can allow a user to specify the behavior of the stream-partitioning component 502. For example, the configuration component 126 can allow the user to specify the number of video segments, the length of T_{accel}, the spatial relationship of the video streams on the display device(s) 132, and so. For instance, FIG. 6 shows an example in which the three regions (604, 606, 608) are arranged in a horizontal row across a screen. But the user can configure the computing device 102 such that the computing system 102 arranges the three regions in a vertical column. In other cases, the user can configure the computing device 102 to present the regions in a two-dimensional matrix, which may be appropriate when there is a relatively large number of streams to simultaneously present; for instance, the computing device can provide a 3×3 array when f=9.

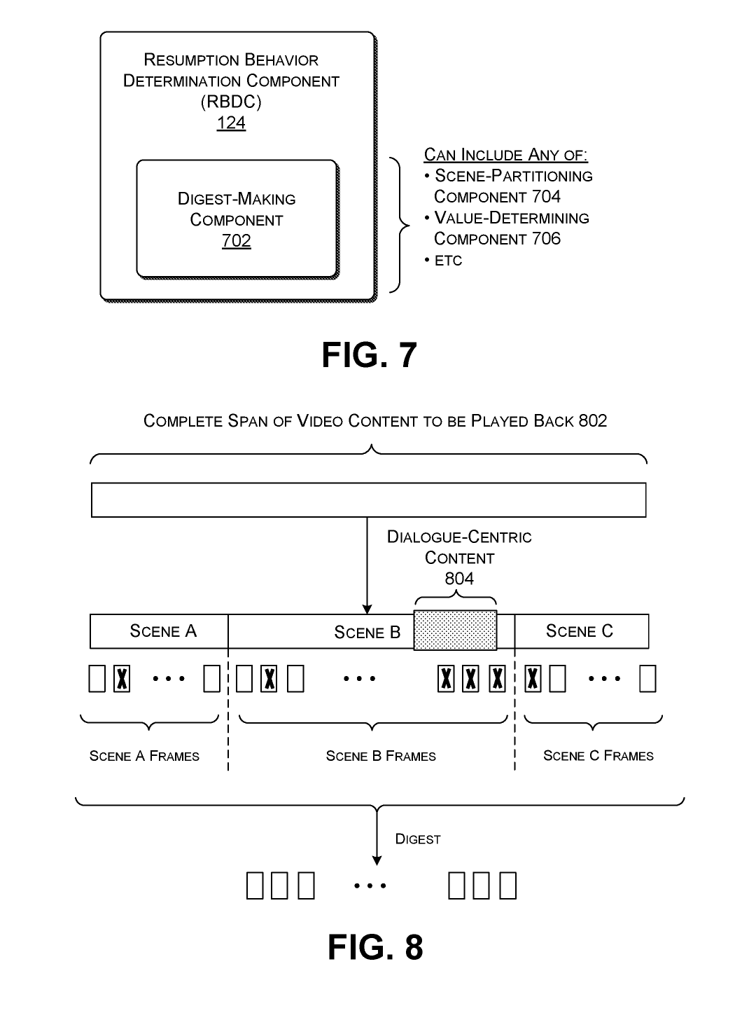

FIG. 7 shows another implementation of the RBDC 124. Here, a digest-making component 702 first identifies the amount of time (T_{accel}) over which the speed-up operation is performed. For instance, the digest-making component 702 can use a fixed value for T_{accel}. Or the digest-making component 702 can compute the value T_{accel} as a function of the temporal length of Section s3, e.g., in the manner described above. The digest-making component 702 can then identify the entire span of video content N_{Ftotal} to be presented in T_{accel}. This span of video content begins with the video frame position Fₛ₃ₛₜₐᵣₜ at the start of Section s3 and ends with the target frame position F_{target} at the end of Section s4.

The digest-making component 702 then forms a digest N_{digest} of the entire span of video content N_{Ftotal}. The digest represents an abbreviated version of the entire span of video content. Generally, the digest N_{digest} has a fewer number of frames compared to the entire span of the video content N_{Ftotal}. The digest-making component 702 then instructs the video playback component 118 to play back the digest in lieu of the original span of video content. In one case, control component 120 can play the digest at any fixed rate, such as rₙₒᵣₘ, or a rate that depends on the size of the digest and the length of T_{accel}.

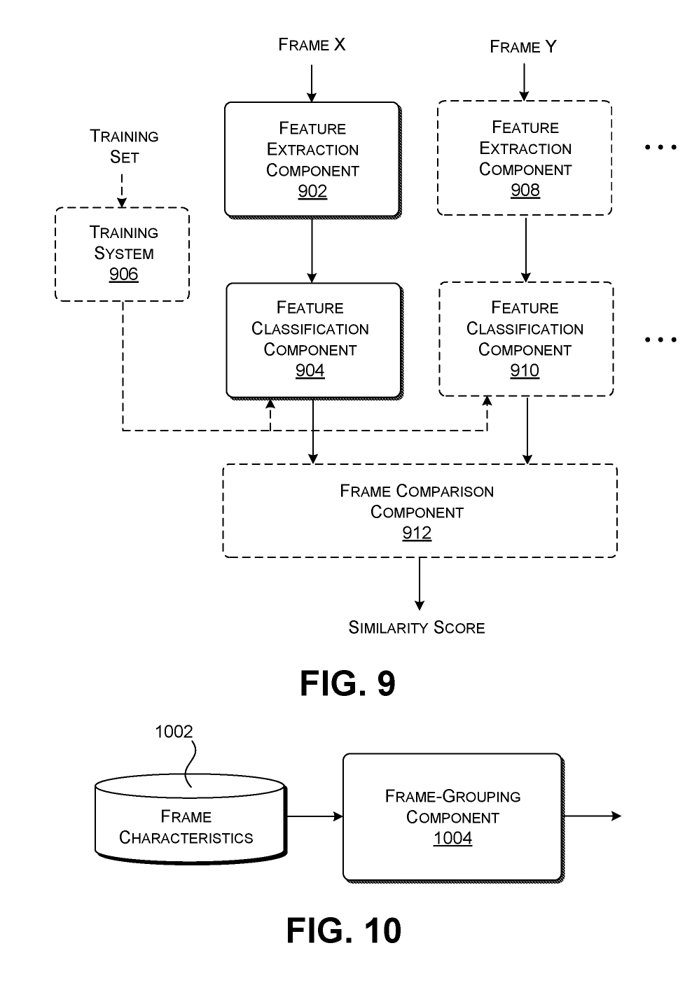

As summarized in FIG. 7, the digest-making component 702 can rely on any one or more subcomponents in making the digest. For instance, the digest-making component 702 can include a scene-partitioning component 704 for identifying distinct scenes within Fₜₒₜₐₗ. A scene refers to a grouping of consecutive video frames having one or more common visual characteristics that distinguish it from other portions of the video stream to be played back. In addition, or alternatively, the digest-making component 702 can include a value-determining component 706 for identifying video content that is assessed as having a high value (e.g., a high importance), and/or video content that is assessed as having a low value (e.g., a low importance). FIGS. 9 and 10 provide additional details regarding the digest-making component 702 and its constituent subcomponents.

FIG. 8 shows one example of the operation of the RBDC 124 of FIG. 7. In this case, the scene-partitioning component 704 identifies three consecutive scenes (A, B, and C) within a complete span of video content 802. The digest-making component 702 can then select representative frames from each scene to compose the digest, while excluding all other frames. For example, the digest-making component 702 can select a prescribed number of key frames from each scene. Or the digest-making component 702 can use the value-determining component 706 to select a subset of frames in each scene that have the highest importance-related scores (which can be identified in the manner described below).

Alternatively, or in addition, the value-determining component 706 can identify low-value frames within the entire span of video content 802. For example, the value-determining component 706 can identify at least one span of consecutive video frames that contains redundant video content with respect to other video content in the entire span of video content 802. The digest-making component 702 can then omit the redundant video content in forming the digest. In this context, the redundant video content constitutes low-value frames.

Alternatively, or in addition, the value-determining component 706 can identify at least one span of video frames that contain visual information that is not necessary to understand the main thrust of media item at this juncture. The digest-making component 702 can then remove this identified video content from the entire span of video content to form the digest. In this context, the identified “unnecessary” video content constitutes low-value video frames. FIG. 8 shows an illustrative segment of video frames 804 that is considered as having low value because it is primarily directed to showing a dialogue among two or more people. Assume that any action depicted in that video segment is incidental to the dialogue, and is not necessary to understand what is happening in the video frames 804.

FIG. 9 shows one implementation of functionality for use in forming a digest, in the context of the RBDC 124 of FIG. 7. A first feature extraction component 902 generates features based on a video frame X. For instance, the feature extraction component 902 can perform any of: Principal Component Analysis (PCA), Kernel PCA analysis, Linear Discriminant Analysis (LDA), Active Shape Model (ASM) processing, Active Appearance Model (AAM) processing, Elastic Bunch Graph Matching (EBGM), Scale-Invariant Feature Transform (SIFT) processing, Hessian matrix processing, and so on. In many cases, the features generated by the feature extraction component 902 describe the principal landmarks in the video frame X. Alternatively, or in addition, the feature extraction component 902 can use a convolutional neural network (CNN) to map the video frame X into a feature vector. Background information regarding the general topic of convolutional neural networks, as applied to image data, can be found in various sources, such as Krizhevsky, et al., “ImageNet Classification with Deep Convolutional Neural Networks,” in Proceedings of the 25th International Conference on Neural Information Processing Systems (NIPS), December 2012, pp. 1097-1105, and in Zagoruyko, et al., “Learning to Compare Image Patches via Convolutional Neural Networks,” in arXiv:1504.03641v1 [cs.CV], April 2015, pp. 1-9.

A feature classification component 904 can classify the video frame X based on the features provided by the feature extraction component 902. In some cases, the feature classification component 904 corresponds to a machine-trained model, such as a linear model, a support vector machine (SVM) model, a neural network model, a decision tree model, etc. A training system 906 produces the machine-trained model in an offline training process based on a set of training data.

Consider the merely illustrative case in which the feature classification component 904 corresponds to a set of binary classifiers, such as binary linear classifiers. Each classifier produces a binary output that indicates whether the video frame X includes particular subject matter that it has been trained to detect.

Consider next the example in which the feature classification component 904 includes a neural network having a series of connected layers. The values zⱼ in any layer j in the neural network can be given by the formula, zⱼ=f(Wⱼzⱼ₋₁+bⱼ), for j=2, . . . N. The symbol Wⱼ denotes the j-th weight matrix produced by the training system 906, and the symbol bⱼ refers to an optional j-th bias vector, also produced by the training system 906. The function f(x) corresponds to any activation function, such as the tanh function. The final layer of the neural network generates a vector in a high-level space. The feature classification component 904 can map the vector to a classification result by determining the proximity (distance) of the vector to another vector having a known classification.

In an optional implementation, the functionality shown in FIG. 9 also includes another feature extraction component 908 and another feature classification component 910. These components (908, 910) perform the same operations described above with respect to another video frame Y. In one case, the feature classification component 910 corresponds to the same kind of machine-trained model as the feature classification component 904 (that operates on the video frame X), and employs the same machine-learned weights as the feature classification component 904. Although not shown, the functionality of FIG. 9 can include additional instances of the feature extraction component 902 and the feature classification component 904 that operate on respective video frames.

An optional frame comparison component 912 compares the video frame X with the video frame Y based on the classification results provided by the feature classification components (904, 910). For example, in the case in which the feature classification components (904, 910) represent binary classifiers, the frame comparison component 912 can identify whether these feature classification components (904, 910) produce the same classification results. In the case in which the feature classification components (904, 910) represent neural networks, the frame comparison component 912 can compute the distance between the output vectors produced by the feature classification components (904, 910). The feature comparison component 912 can compute the distance using any metric, such as cosine similarity, Euclidean similarity, etc.

The digest-making component 702 can leverage the above-described functionality of FIG. 9 in different ways, examples of which are described below. In one case, assume that the video frame X and the video frame Y correspond to two successive video frames in the entire span of video content to be compressed. The digest-making component 702 can use the functionality of FIG. 9 to determine whether the video frame X and the video frame Y represent different scenes e.g., by determining whether the distance between these two frames (provided by the frame comparison component 912) exceeds a prescribed threshold. The digest-making component 702 can repeat this process for each consecutive pair of video frames in the entire span of video content to partition the entire span into its different scenes.

In another example, the digest-making component 702 can use the functionality of FIG. 9 to conclude that the video frame X and the video frame Y depict substantially similar video content, e.g., by determining that the difference between video frame X's output vector and video frame Y's output vector is within a prescribed threshold distance of each other. In response, the digest-making component 702 can mark the video frame Y as redundant content to be excluded in forming the digest.

In another example, the digest-making component 702 can use the feature extraction component 902 and the feature classification component 904 to perform face recognition. The digest-making component 702 then makes a determination whether a face that is recognized in the video frame X (if any) represent a new face compared to the last face that has been encountered in the video stream, prior to the video frame X. If so, the digest-making component 702 can mark the video frame X as a significant frame for inclusion in the digest. For example, consider the case in which a scene of the video stream depicts a speech given to a group of people. The digest-making component 702 can leverage the above-described capability to form a compressed montage of different people's reaction to the speech.

In another example, the digest-making component 702 can use the feature extraction component 902 and the feature classification component 904 to generate a binary classification result or a score that measures the extent to which the video frame X is significant. If the video frame X is deemed significant, the feature classification component 904 can mark the video frame for inclusion in the digest. To perform this operation, the training system 906 produces a machine-trained model based on a set of training images that have been annotated with labels to reflect their assessed significance. (These labels can be supplied through a manual process or an automated or semi-automated process.) The resultant machine-trained model reflects the judgments contained in that training set, without the need for a human developer to articulate a discrete set of handcrafted importance-assessment rules.

In an alternative version to the functionality of FIG. 9, the feature classification component 904 can receive features associated with a sub-span of n consecutive video frames, rather than a single video frame X. The feature classification component 904 can map the sub-span of video frames into a binary classification result or a score in the manner described above, e.g., using a set of binary classifiers, a neural network, etc. The digest-making component 702 can leverage this implementation to perform any of the digest-forming operations described above.

The digest-making component 702 can also leverage the alternative version of FIG. 9 to determine whether a sub-span of images pertains to a dialogue-rich portion that lacks interesting video content. This finding supports a conclusion that the sub-span of video frames can be adequately represented by the accompanying audio frames, without the accompanying video content. In response to such a finding, the digest-making component 702 can omit the sub-span of video frames from the digest. To improve its classification result, the feature classification component 904 can also receive features that describe the other content associated with the sub-span of video frames. That other content may be reflected, for instance, in text-based close-captioning information associated with the video frames.

FIG. 10 shows additional functionality that the digest-making component 702 can leverage to make the digest. A data store 1002 stores information that characterizes all (or a subset) of the video frames in the entire span of video content (for which the digest is being computed). For instance, for each video frame in the span, the data store 1002 can store the features computed by the feature extraction component 902, and/or the classification result produced by the feature classification component 904. A frame-grouping component 1004 performs a clustering operation (e.g., using a k-means the, a hierarchical method, etc.) to identify groups of video frames that have similar characteristics. In other words, whereas the functionality of FIG. 9 determines the similarity of one video frame with respect to another video frame, the functionality of FIG. 10 identifies groups of similar video frames within the entire set of video content to be compressed.

The digest-making component 702 can use the functionality of FIG. 10 in different ways. For example, the digest-making component 702 can use the functionality of FIG. 10 to identify sub-spans of consecutive video frames that pertain to the same subject matter, which may correspond to distinct scenes. That is, the digest-making component 702 can map different clusters produced by the frame-grouping component 1004 to different scenes. The digest-making component 702 can then select representative video frames from each cluster to form the digest.

In some implementations, the functionality of FIGS. 9 and 10 produces an initial set of frames that meet the specified selection criteria. The functionality may then further cull the initial set of frames to produce a digest having an appropriate size (and consequent duration). For example, consider in which the case in which the functionality assigns importance-related scores to each video frame. The functionality may perform a culling operation by selecting the frames having the highest scores. In other implementations, the functionality of FIGS. 9 and 10 can perform its scoring and culling in a single operation. The functionality can perform this operation by updating top n most important frames after analyzing and scoring each new video frame.

The above-described implementations of the digest-making component 702 are set forth in the spirit of illustration, not limitation. Other implementations can produce a digest in different ways.

As a final point in Subsection A.1, the computing device 102 has been described for the example in which the control component 120 suspends the video stream while the audio stream continues to play at the normal playback rate, rₙₒᵣₘ. But the control component 120 can produce the opposite effect, e.g., by suspending the audio stream (or otherwise playing it at some rate rₚₐᵤₛₑ) while the video stream continues to play at rₙₒᵣₘ. The control component 120 would then speed up the playback of the audio stream when a resynchronization-initiation event is achieved, until that time as the audio stream catches up to the current frame position of the video stream. This variation and others are further described in the following subsection.

A.2. Decoupled Playback of other Streams of Media Content

FIG. 11 shows an overview of a computing device 1102 for desynchronizing the playback of a stream of first media content and a stream of second media content, upon detecting a desynchronization event. The computing device 1102 of FIG. 11 represents a more general counterpart to the computing device 102 of FIG. 1.

The computing device 1102 receives a media content item having two or more streams of media content from a media item source 1104. The streams can include any combination of content, including, but not limited to: one or more audio streams, one or more video streams, one or more game-related streams, one or more close-caption streams, one or move audio annotation streams (for the visually impaired), and so on. FIG. 11 will generally be described in the context of two representative streams, a first media stream and a second media stream. But the principles set forth herein can be extended to any number of streams.

A playback component 1106 plays the media item. The playback component 1106 includes a preprocessing component 1108 that performs preprocessing on the media streams, e.g., by demultiplexing the streams, decompressing the streams, performing error correction on the streams, etc. A first media playback component 1110 controls the final playback of the first media stream, while a second media playback component 1112 controls the final playback of the second media stream.

A trigger component 1114 performs the same functions described above with respect to the explanation of FIG. 2. That is, the trigger component 1114 receives input signals, any of which may reflect an occurrence that impacts the attention that the user is able to devote to one or more of the media streams. The trigger component 1114 determines whether a trigger event has occurred on the basis of the input signals. The trigger event may correspond to a desynchronization event or a resynchronization-initiation event.

The trigger component 1114 performs the additional task of determining what media stream(s) are impacted by the trigger event. For instance, assume that the input signals indicate that the user has received a telephone call. The trigger component 1114 may conclude that the user's attention to the audio stream will be negatively affected, but not the video stream. In another case, assume that input signals indicate that the user has begun interacting with another user device. The trigger component 1114 can conclude that the user's attention to the video stream will be negatively affected, but not the audio stream.

In one implementation, the trigger component 1114 can make the above type of conclusions by consulting a set of environment-specific rules, e.g., which can be embodied in a lookup table or a machine-learned model, etc. That lookup table or model maps each input signal type (or combination of input signal types) into an indication of the media stream(s) that may be affected by the incident associated with the input signals. For instance, the lookup table or model can indicate whether an occurrence maps to any combination of: eyes busy; ears busy; and/or mind busy. An “eyes busy” distraction will prevent the user from consuming a video stream. An “ears busy” distraction will prevent the user from consuming an audio stream. A “mind busy” distraction will prevent the user from engaging in some mental task, such as reading a close-captioning stream, or listening to audible instructions. In those cases in which the distraction affects all aspects of the user's attention, the control component 1116 can pause all of its streams until the distraction is removed. For instance, the lookup table or the model can map a fire alarm to a conclusion that the media item should be suspended in its entirety.

A control component 1116 governs the playback of the first media stream and/or the second media stream based on the trigger events generated by the trigger component 1114. The control component 1116 includes a deceleration behavior determination component (DBDC) 1118 and a resumption behavior determination component (RBDC) 1120 that perform the same operations described above. For example, the DBDC 1118 can use any equation(s), algorithm(s), rule(s), etc. to decrease the rate at which at least one media stream is presented relative to another media stream. Similarly, the RBDC 1120 can use any equation(s), algorithm(s), rule(s), etc. to increase the rate at which at least one media stream is presented relative to another media stream. Alternatively, the RBDC 1120 can partition a media stream into plural component segments, and then simultaneously play those segments. Alternatively, the RBDC 1120 can form and play a digest of a media stream using any of the techniques described above. In other words, the DBDC 1118 and the RBDC 1120 can apply any of the techniques described in FIGS. 3-10, but, in the case of FIG. 11, to the more general task of controlling the playback of either the first media stream or the second media stream, or both of these media streams.

A configuration component 1122 allows a user to control any aspect of the behavior of the control component 1116. For instance, a user can interact with the configuration component 1122 to choose a mode that will be subsequently applied by the DBDC 1118 and/or the RBDC 1120, and/or to choose any parameter (e.g., T_{accel}) used by the DBDC 1118 and/or RBDC 1120, etc.

Playback equipment 1124 plays the first media stream on one or more first media playback devices 1126, and plays the second media stream on one or more second media playback devices 1128.

The operations described in Subsection A.1 can also be extended in additional ways. In a first variation, the trigger component 1114 need not detect an explicit resynchronization-initiation event in response to input signals. Rather, the control component 1116 can automatically invoke a resynchronization-initiation event a prescribed amount of time after the receipt of the desynchronization event.

In a second variation, the control component 1116 can simultaneously modify the playback of both the first media stream and the second media stream in response to receiving a desynchronization event and a resynchronization-initiation event. For instance, the control component 1116 can adjust the rates at which both media streams are presented, but to different degrees, and/or using different functions, etc.

In a third variation, the control component 1116 can perform the behavior described in Subsection A.1 with respect to two media streams of the same type. For example, assume that a media item is composed to two audio streams, e.g., corresponding to background sounds and foreground sounds (e.g., dialogue). The control component 1116 can perform the pause-and-resume behavior described in Subsection A.1 on one of the audio streams, while playing the other audio stream at the normal playback rate.

In a fourth variation, the control component 1116 can automatically determine a deceleration and/or resumption strategy based on the circumstance in which a trigger event has occurred. For example, the RBDC 1120 can choose among a set of possible resumption strategies depending on the length of time that a video stream has been paused. For instance, the RBDC 1120 can choose the strategy shown in FIGS. 5 and 6 (in which the span of video to be accelerated is broken into plural segments) only when the length of time that the video stream has been paused exceeds an environment-specific threshold value. Otherwise, the control component 1116 can use the strategy shown in FIGS. 3 and 4.

In another example of the fourth variation, the RBDC 1120 can choose among a set of possible resumption strategies depending on the computing capabilities of the computing device 1102. For example, assume that the control component 1116 detects that the computing device 1102 has processing resources and/or memory resources below a prescribed threshold level of resources. If so, when a resynchronization-initiation event is received, the RBDC 1120 can generate a reduced-resolution version of the video stream for accelerated playback in Section s4, rather than a full resolution version of the video stream. The RBDC 1120 can produce a reduced resolution version of the video stream in various ways, such as by reducing the resolution of each video frame, and/or by reducing the number of video frames to be played back. In another case, the RBDC 1120 may address the limited resources of the computing device 102 by increasing the length of the time (T_{accel}) over which the video stream is played back in Section s4 following a resynchronization-initiation event.

In another example of the fourth variation, the DBDC 1118 can choose among a set of possible resumption strategies depending the type of desynchronization event that has been received. For instance, the DBDC 1118 can choose the length of Section s2 (T_{slowdown}) based on the type of desynchronization event that has been received. For example, the DBDC 1118 can choose a T_{slowdown} for an alarm condition that is shorter than a T_{slowdown} for a non-alarm condition, based on the assumption that the user will more quickly attend to an alarm condition compared to any other distraction. Alternatively, or in addition, the DBDC 1118 can choose a different slow-down function for different desynchronization events, e.g., by choosing a decay function for a first kind of desynchronization event and an abrupt step function for a second kind of desynchronization event.

In a fifth variation, the control component 1116 can use additional techniques to form a digest when compressing other non-video media streams, compared those discussed thus far. For example, consider the case in which the digest-making component 702 seeks to produce a compressed version of an audio stream. The digest-making component 702 can do so by eliminating periods of silence from the span of audio content to be compressed, and/or by eliminating periods that include sound but do not contain human speech. Consider next the case in which the digest-making component 702 seeks to produce a compressed version of a text-based close-captioning stream. The digest-making component 702 can do so by concatenating a stream of close-captioned messages into a single record. The computing device 1102 can present the concatenated record as a single block, e.g., by scrolling that single block across a user interface presentation at a given rate (e.g., in the manner of movie credits).

In a sixth variation, the control component 1116 can also use one or more non-visual streams when interpreting a visual stream. For example, the control component 1116 can use a close-captioning stream or an audio explanation track (intended for use by the visually impaired) to help interpret the visual content in the accompanying parts of the visual stream. Or the control component 1116 can exclusively use non-visual content in interpreting the visual stream.

In a seventh variation, the control component 1116 can combine any two or more compression techniques that were described above as alternative modes. For example, the control component 1116 can form a digest, and then play the digest back at an accelerated playback rate, as governed by one or more playback equations.

In an eighth variation, the trigger component 1114 can generate a desynchronization event when the user commences a rewind or fast-forward operation, e.g., by pressing and holding down a rewind or fast-forward control, starting at an original video frame position VF_{original}. Consider the case in which the first media stream is an audio stream and the second media stream is a video stream. In the course of the user's fast-forward operation, the control component 1116 can suspend the normal playback of the video stream while continuing to play the audio stream. The trigger component 1114 can subsequently issue a resynchronization-initiation event when the user selects a new location in the video stream. Assume that this new selected position represents a later video frame position VF_{new} with respect to the original video frame position VF_{original}. In a first implementation, the control component 1116 can speed up the playback of at least the audio stream until it catches up to the newly selected video frame position. This implementation may be appropriate when the user has already viewed an accelerated playback of the video stream as a byproduct of fast-forwarding through this video content. In a second implementation, the control component 1116 can speed up the playback of both the audio stream and the video frame after the user selects the new video frame position; in this speed-up operation, the control component 1116 can begin its accelerated playback at VF_{original}.

In a ninth variation, the control component 1116 can automatically advance the media streams to any frame position upon receiving a resynchronization-initiation event. For example, assume that the trigger component 1114 detects a resynchronization-initiation event at time tₓ, in which the audio stream has advanced to an appropriate audio frame position A_{Fx} associated with the time tₓ. In the above examples, the control component 1116 operates to rejoin the audio stream and the video stream at some later juncture, F_{target}, which is reached by continuing to play the audio stream at the normal playback rate, rₙₒᵣₘ. As a consequence, the user will perceive no disruption in the playback of the audio stream. But more generally, the control component 1116 can advance the video stream and the audio stream to any frame position, e.g., prior to AFₓ, after AFₓ, or to AFₓ itself; further, this operation can potentially involve rewinding or fast-forwarding the audio stream. For example, assume that a length of time between a desynchronization event and a resynchronization-initiation event (T_{desync}=T_{slowdown}+Tₚₐᵤₛₑ) is five minutes. The control component 1116 can determine that this T_{desync} period exceeds an environment-specific maximum duration value. In response, the control component 1116 can advance the audio stream and the video stream to a frame position that occurs three minutes after the desynchronization event has been received, upon detecting a resynchronization-initiation event (where three minutes is an example of any configurable environment-specific restart time). Alternatively, or in addition, the video control component 1116 can invoke this rewind behavior when it determines that the video content that has been skipped satisfies one or more importance-based measures, and/or based on a preference setting by an individual user.

The above variations are set forth in the spirit of illustration, not limitation. Other implementations can include other variations.

B. Illustrative Processes

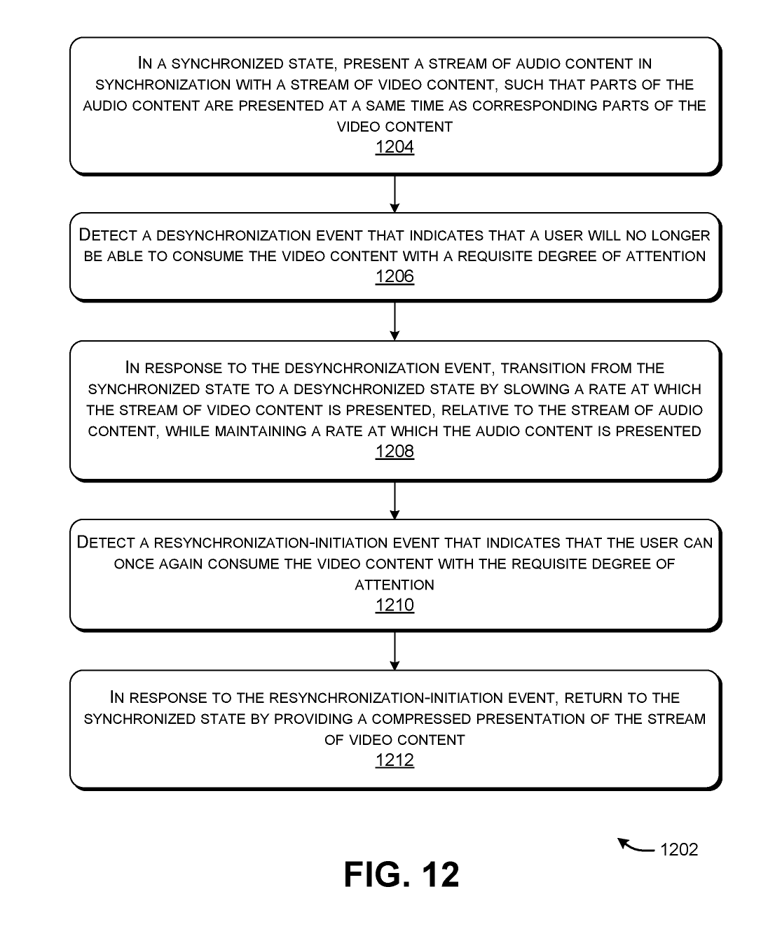

FIGS. 12-15 show processes that explain one manner of operation of the computing devices (102, 1102) of Section A in in flowchart form. Since the principles underlying the operation of the computing devices (102, 1102) have already been described in Section A, certain operations will be addressed in summary fashion in this section. As noted in the prefatory part of the Detailed Description, each flowchart is expressed as a series of operations performed in a particular order. But the order of these operations is merely representative, and can be varied in any manner.

Beginning with FIG. 12, this figure shows a process 1202 that represents one manner of operation of the computing device 102 of FIG. 1. In block 1204, in a synchronized state, the computing device 102 presents a stream of audio content in synchronization with a stream of video content, such that parts of the audio content are presented at a same time as corresponding parts of the video content. In block 1206, the computing device 102 detects a desynchronization event that indicates that a user will no longer be able to consume the video content with a requisite degree of attention. In block 1208, in response to the desynchronization event, the computing device 102 transitions from the synchronized state to a desynchronized state by slowing a rate at which the stream of video content is presented, relative to the stream of audio content, while maintaining a rate at which the audio content is presented. In block 1210, the computing device detects a resynchronization-initiation event that indicates that the user can once again consume the video content with the requisite degree of attention. In block 1212, in response to the resynchronization-initiation event, the computing device 102 returns to the synchronized state by providing a compressed presentation of the stream of video content. The compressed presentation is formed based on video content that was not presented at a same time as corresponding portions of the audio content in the desynchronization state.

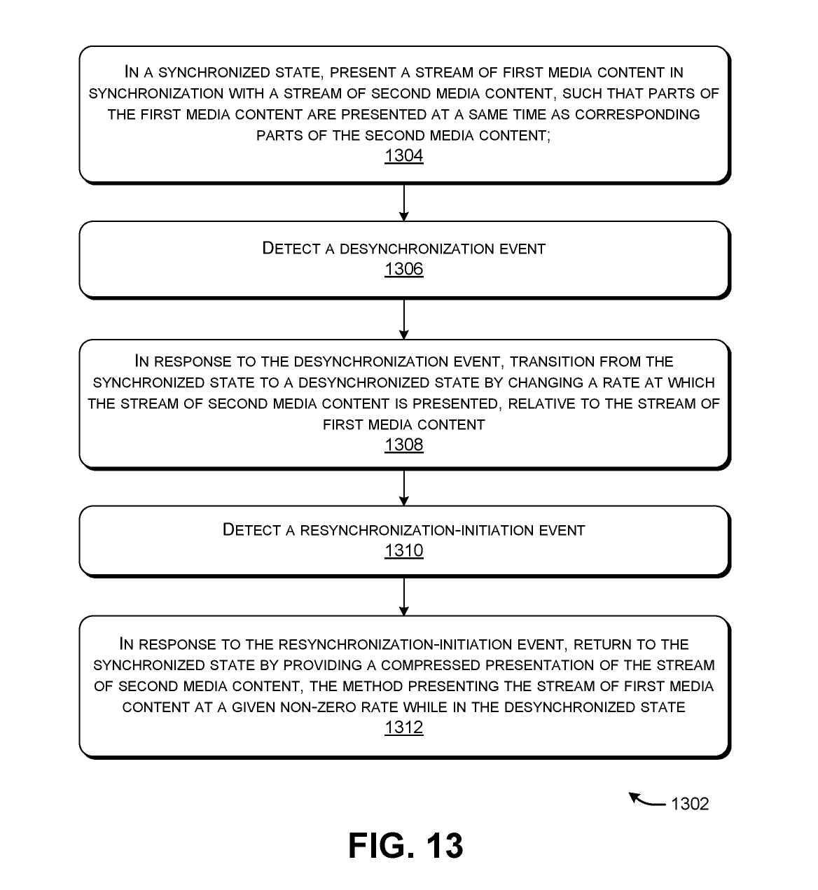

FIG. 13 shows a process 1302 that represents one manner of operation of the computing device 1102 of FIG. 11. In block 1304, in a synchronized state, the computing device 1102 presents a stream of first media content in synchronization with a stream of second media content, such that parts of the first media content are presented at a same time as corresponding parts of the second media content. In block 1306, the computing device 1102 detects a desynchronization event. In block 1308, in response to the desynchronization event, the computing device 1102 transitions from the synchronized state to a desynchronized state by changing a rate at which the stream of second media content is presented, relative to the stream of first media content. In block 1310, the computing device 1102 detects a resynchronization-initiation event. In block 1312, in response to the resynchronization-initiation event, the computing device 1102 returns to the synchronized state by providing a compressed presentation of the stream of second media content. The compressed presentation is formed based on second media content that was not presented at a same time as corresponding portions of the first media content in the desynchronization state. The process 1302 also presents the stream of first media content at a given non-zero rate while in the desynchronized state.

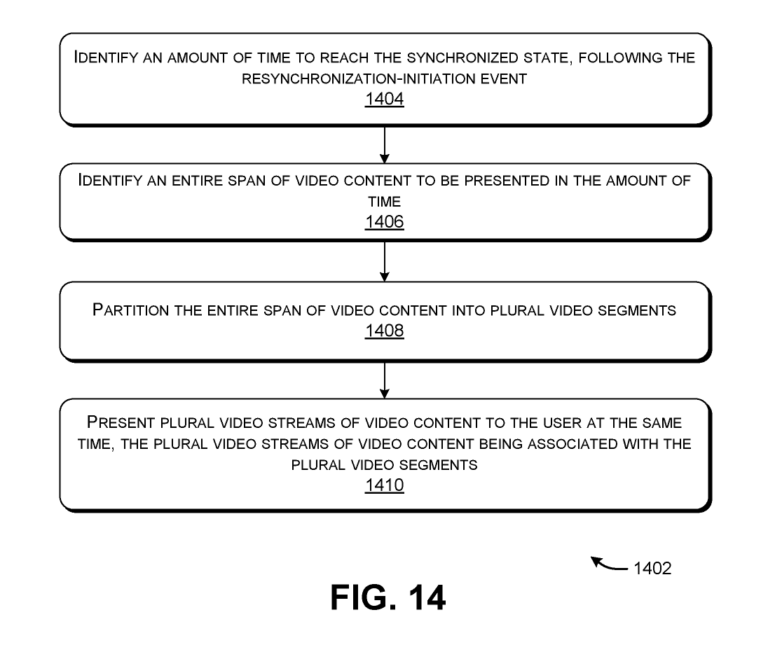

FIG. 14 shows a process 1402 that represents one manner of operation of the RBDC 124 of FIG. 5. In block 1404, the RBDC 124 identifies an amount of time to reach the synchronized state, following the resynchronization-initiation event. In block 1406, the RBDC 124 identifies an entire span of video content to be presented in the amount of time computed in block 1404. In block 1408, the RBDC 124 partitions the entire span of video content into plural video segments, each corresponding to a temporal sub-span of the entire span. In block 1410, the RBDC 124 present plural video streams of video content to the user at the same time, the plural video streams of video content being associated with the plural video segments. More generally, FIG. 14 can be applied with respect to any stream of first media content and any stream of second media content. In the particular context of FIG. 14, the first media content corresponds to audio content, and the second media content corresponds to video content.

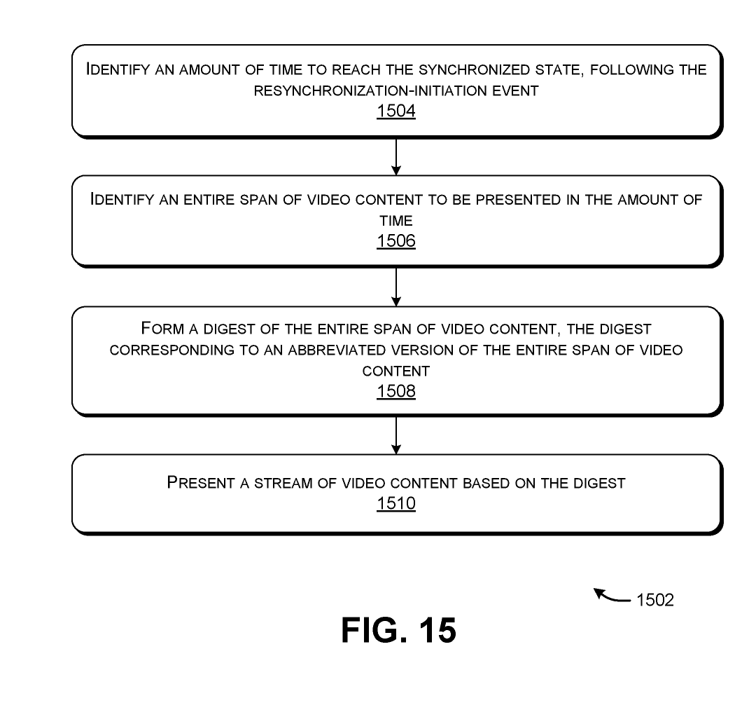

FIG. 15 shows a process 1502 that represents one manner of operation of the RBDC 124 of FIG. 7. In block 1504, the RBDC 124 identifies an amount of time to reach the synchronized state, following the resynchronization-initiation event. In block 1506, the RBDC 124 identifies an entire span of video content to be presented in the amount of time determined in block 1504. In block 1508, the RBDC 124 forms a digest of the entire span of video content, the digest corresponding to an abbreviated version of the entire span of video content. In block 1510, the RBDC 124 presents a stream of video content based on the digest. More generally, FIG. 15 can be applied with respect to any stream of first media content and any stream of second media content. In the particular context of FIG. 15, the first media content corresponds to audio content, and the second media content corresponds to video content.

C. Representative Computing Functionality

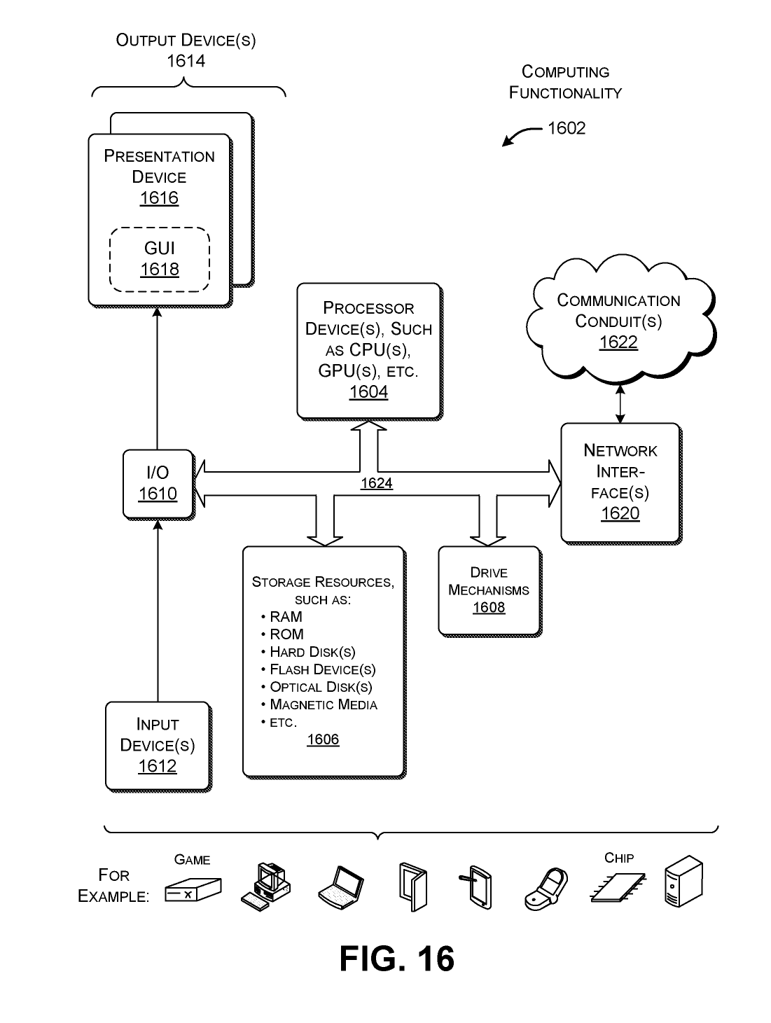

FIG. 16 shows computing functionality 1602 that can be used to implement any aspect of the mechanisms set forth in the above-described figures. For instance, the type of computing functionality 1602 shown in FIG. 16 can be used to implement the computing device 102 of FIG. 1 or the computing device 1102 of FIG. 11. In all cases, the computing functionality 1602 represents one or more physical and tangible processing mechanisms.

The computing functionality 1602 can include one or more hardware processor devices 1604, such as one or more central processing units (CPUs), and/or one or more graphics processing units (GPUs), and so on. The computing functionality 1602 can also include any storage resources (also referred to as computer-readable storage media or computer-readable storage medium devices) 1606 for storing any kind of information, such as machine-readable instructions, settings, data, etc. Without limitation, for instance, the storage resources 1606 may include any of RAM of any type(s), ROM of any type(s), flash devices, hard disks, optical disks, and so on. More generally, any storage resource can use any technology for storing information. Further, any storage resource may provide volatile or non-volatile retention of information. Further, any storage resource may represent a fixed or removable component of the computing functionality 1602. The computing functionality 1602 may perform any of the functions described above when the hardware processor device(s) 1604 carry out computer-readable instructions stored in any storage resource or combination of storage resources. For instance, the computing functionality 1602 may carry out computer-readable instructions to perform each block of the processes of FIGS. 12-15. The computing functionality 1602 also includes one or more drive mechanisms 1608 for interacting with any storage resource, such as a hard disk drive mechanism, an optical disk drive mechanism, and so on.

The computing functionality 1602 also includes an input/output component 1610 for receiving various inputs (via input devices 1612), and for providing various outputs (via output devices 1614). Illustrative input devices include a keyboard device, a mouse input device, a touchscreen input device, a digitizing pad, one or more static image cameras, one or more video cameras, one or more depth camera systems, one or more microphones, a voice recognition mechanism, any movement detection mechanisms (e.g., accelerometers, gyroscopes, etc.), and so on. One particular output mechanism may include a display device 1616 and an associated graphical user interface presentation (GUI) 1618, e.g., corresponding to one of the display devices 132 shown in FIG. 1. The display device 1616 may correspond to a liquid crystal display device, a cathode ray tube device, a projection mechanism, etc. Other output devices include a printer, one or more speakers, a haptic output mechanism, an archival mechanism (for storing output information), and so on. The computing functionality 1602 can also include one or more network interfaces 1620 for exchanging data with other devices via one or more communication conduits 1622. One or more communication buses 1624 communicatively couple the above-described components together.

The communication conduit(s) 1622 can be implemented in any manner, e.g., by a local area computer network, a wide area computer network (e.g., the Internet), point-to-point connections, etc., or any combination thereof. The communication conduit(s) 1622 can include any combination of hardwired links, wireless links, routers, gateway functionality, name servers, etc., governed by any protocol or combination of protocols.

Alternatively, or in addition, any of the functions described in the preceding sections can be performed, at least in part, by one or more hardware logic components. For example, without limitation, the computing functionality 1602 (and its hardware processor) can be implemented using one or more of: Field-programmable Gate Arrays (FPGAs); Application-specific Integrated Circuits (ASICs); Application-specific Standard Products (ASSPs); System-on-a-chip systems (SOCs); Complex Programmable Logic Devices (CPLDs), etc. In this case, the machine-executable instructions are embodied in the hardware logic itself

The following summary provides a non-exhaustive list of illustrative aspects of the technology set forth herein.

According to a first aspect, a computer-readable storage medium is described for storing computer-readable instructions. The computer-readable instructions, when executed by one or more processor devices, perform a method that includes: in a synchronized state, presenting a stream of audio content in synchronization with a stream of video content, such that parts of the audio content are presented at a same time as corresponding parts of the video content; detecting a desynchronization event that indicates that a user will no longer be able to consume the video content; in response to the desynchronization event, transitioning from the synchronized state to a desynchronized state by slowing a rate at which the stream of video content is presented, relative to the stream of audio content, while maintaining a rate at which the audio content is presented; detecting a resynchronization-initiation event that indicates that the user can once again consume the video content; and in response to the resynchronization-initiation event, returning to the synchronized state by providing a compressed presentation of the stream of video content.

According to a second aspect, a method, performed by a computing device, is described for playing a media item having plural components of media content. The method includes: in a synchronized state, presenting a stream of first media content in synchronization with a stream of second media content, such that parts of the first media content are presented at a same time as corresponding parts of the second media content; detecting a desynchronization event; in response to the desynchronization event, transitioning from the synchronized state to a desynchronized state by changing a rate at which the stream of second media content is presented, relative to the stream of first media content; detecting a resynchronization-initiation event; and in response to the resynchronization-initiation event, returning to the synchronized state by providing a compressed presentation of the stream of second media content. The compressed presentation is formed based on second media content that was not presented at a same time as corresponding portions of the first media content in the desynchronization state. Further, the method involves presenting the stream of first media content at a given non-zero rate while in the desynchronized state.

According to a third aspect (depending from the second aspect, for example), the desynchronization event corresponds to a determination that a user will no longer be able to attend to a presentation of the second media content. The resynchronization-initiation event corresponds to a determination that the user can once again attend to the presentation of the stream of second media content.

According to a fourth aspect (depending from the second aspect, for example), the method further includes determining that the desynchronization event is a type of event that warrants slowing the rate at which the stream of second media content is presented, relative to the stream of first media content, rather than vice versa.

According to a fifth aspect (depending from the second aspect, for example), the first media content is audio content, and the second media content is video content.

According to a sixth aspect (depending from the second aspect, for example) the given non-zero rate at which the stream of first media content is presented in the desynchronized state is a same rate at which the stream of first media content is presented in the synchronized state.

According to a seventh aspect (depending from the second aspect, for example), the changing operation includes slowing the rate at which the stream of second media content is presented based on a prescribed slow-down function, until the rate at which the stream of second media content equals a prescribed second media pause rate.

According to an eighth aspect (depending from the second aspect, for example), the operation of returning to the synchronized state includes increasing the rate at which the stream of second media content is presented based on a prescribed speed-up function, until the synchronized state is achieved.

According to a ninth aspect, the resumption function (described in the eighth aspect) includes at least one part that corresponds to a nonlinear function.

According to a tenth aspect (depending from the second aspect, for example), the operation of returning to the state includes: assessing an amount of time in which the stream of first media content has been presented in desynchronization with the stream of second media content; and choosing a second media resumption strategy based, at least in part, on the amount of time.

According to an eleventh aspect (depending from the second aspect, for example), the operation of returning to the state includes: assessing a processing capability of the computing device; and choosing a second media resumption strategy based, at least in part, on the processing capability.

According to a twelfth aspect (depending from the second aspect, for example), the operation of returning to the state includes: identifying an amount of time to reach the synchronized state, following the resynchronization-initiation event; identifying an entire span of second media content to be presented in the amount of time; partitioning the entire span of second media content into plural second media content segments, each second media content segment corresponding to a temporal sub-span of the entire span of second media content; and presenting plural second media streams of second media content to the user at a same time, the plural second media streams of second media content being associated with the plural second media segments.

According to a thirteenth aspect (depending from the second aspect, for example), the operation of returning to the state includes: identifying an amount of time to reach the synchronized state, following the resynchronization-initiation event; identifying an entire span of second media content to be presented in the amount of time; forming a digest of the entire span of second media content, the digest corresponding to an abbreviated version of the entire span of second media content; and presenting a stream of second media content based on the digest.

According to a fourteenth aspect, the above-referenced operation of forming a digest (with respect to the thirteenth aspect) includes: identifying different scenes within the entire span of second media content; and selecting representative portions of the different scenes to produce the digest.

According to a fifteenth aspect, the above-referenced operation of forming a digest (with respect to the thirteenth aspect) includes: identifying low-value portions in the entire span of second media content, wherein the low-value portions are assessed with respect to one or more characteristics; and eliminating the low-value portions to produce the digest.

According to a sixteenth aspect, one kind of low-value portion corresponds to a portion that is assessed as redundant with respect to at least one other portion.

According to a seventeenth aspect, the above-referenced operation of forming a digest (with respect to the thirteenth aspect) includes: identifying high-value portions in the entire span of second media content, wherein the high-value portions are assessed with respect to one or more characteristics; and including at least some of the high-value portions in the digest.

According to an eighteenth aspect, a computing device is described for playing a media item. The computing device includes a first media playback component configured to present a stream of first media content, and a second media playback component configured to present a stream of second media content. When operating in a synchronized state, the first media playback component and the second media playback component are configured to present the stream of first media content in synchronization with the stream of second media content, such that parts of the first media content are presented at a same time as corresponding parts of the second media content. The computing device also includes a trigger component configured to detect trigger events in response to at least one input signal. The computing device also includes a deceleration behavior determination component (DBDC) configured to: receive a desynchronization event from the trigger component; and, in response to the desynchronization event, transition from the synchronized state to a desynchronized state by instructing the second media playback component to slow a rate at which the stream of second media content is presented, relative to the stream of first media content. The computing device also includes a resumption behavior determination component (RBDC) configured to: detect a resynchronization-initiation event from the trigger component; and, in response to the resynchronization-initiation event, return to the synchronized state by instructing the second media playback component to provide a compressed presentation of the stream of second media content. The compressed presentation is formed based on second media content that was not presented at a same time as corresponding portions of the first media content in the desynchronization state. Further, the first media playback component is configured to present the stream of first media content at a given non-zero rate throughout the synchronized state and the desynchronized state.

According to a nineteenth aspect (depending from the eighteenth aspect, for example), the desynchronization event corresponds to a determination that a user will no longer be able attend to a presentation of the second media content. The resynchronization-initiation event corresponds to a determination that the user can once again attend to the presentation of the stream of second media content.

According to a twentieth aspect (depending on the eighteenth aspect, for example), the first media content is audio content, and the second media content is video content.

A twenty-first aspect corresponds to any combination (e.g., any permutation or subset that is not logically inconsistent) of the above-referenced first through twentieth aspects.

A twenty-second aspect corresponds to any method counterpart, device counterpart, system counterpart, means-plus-function counterpart, computer-readable storage medium counterpart, data structure counterpart, article of manufacture counterpart, graphical user interface presentation counterpart, etc. associated with the first through twenty-first aspects.

In closing, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-readable storage medium storing computer-readable instructions, the computer-readable instructions, when executed by one or more processor devices, performing a method that comprises:
in a synchronized state, presenting a stream of audio content in synchronization with a stream of video content using a playback application, the playback application presenting parts of the audio content concurrently with corresponding parts of the video content;
detecting a desynchronization event that indicates that a user has interacted with another application other than the playback application;
in response to the desynchronization event, transitioning from the synchronized state to a desynchronized state by slowing a rate at which the stream of video content is presented by the playback application, relative to the stream of audio content, while maintaining a rate at which the stream of audio content is presented by the playback application;
detecting a resynchronization-initiation event that indicates that the user can once again consume the video content; and
in response to the resynchronization-initiation event, returning to the synchronized state by providing a compressed presentation of the stream of video content via the playback application.

2. A method, performed by a computing device, the method comprising:
in a synchronized state, presenting a stream of first media content of a media item in synchronization with a stream of second media content of the media item, wherein parts of the stream of first media content are presented at a same time as corresponding parts of the stream of second media content;
detecting a desynchronization event;
in response to the desynchronization event, transitioning from the synchronized state to a desynchronized state by changing a rate at which the stream of second media content is presented relative to the stream of first media content while continuing to present the stream of first media content at a non-zero rate;
detecting a resynchronization-initiation event; and
in response to the resynchronization-initiation event, returning to the synchronized state by providing a digest of the second media content, the digest comprising an abbreviated set of video frames from the stream of second media content.

3. The method of claim 2,
wherein the desynchronization event corresponds to a determination that a user will no longer be able to attend to a presentation of the stream of second media content; and
wherein the resynchronization-initiation event corresponds to a determination that the user can once again attend to the presentation of the stream of second media content.

4. The method of claim 3, further comprising:
detecting the desynchronization event when a user of the media item diverts attention away from a display device showing the media item; and
detecting the resynchronization-initiation event when the user of the media item returns attention to the display device showing the media item.

5. The method of claim 2, wherein the first media content is audio content, and the second media content is video content.

6. The method of claim 2, wherein the stream of first media content is presented in the desynchronized state at the same rate at which the stream of first media content is presented in the synchronized state.

7. The method of claim 2, wherein said changing comprises slowing the rate at which the stream of second media content is presented based at least on a prescribed slow-down function, until the rate at which the stream of second media content equals a prescribed second media pause rate.

8. The method of claim 2, wherein said returning to the synchronized state comprises increasing the rate at which the stream of second media content is presented based at least on a prescribed speed-up function, until the synchronized state is achieved.

9. The method of claim 8, wherein the prescribed speed-up function includes at least one part that corresponds to a nonlinear function.

10. The method of claim 2, wherein said returning to the synchronized state comprises:
assessing an amount of time in which the stream of first media content has been presented in desynchronization with the stream of second media content; and
choosing a second media resumption strategy based, at least in part, on the amount of time.

11. The method of claim 2, wherein said returning to the synchronized state comprises:
assessing a processing capability of the computing device; and
choosing a second media resumption strategy based, at least in part, on the processing capability.

12. The method of claim 2, wherein said returning to the synchronized state comprises:
identifying an amount of time to reach the synchronized state, following the resynchronization-initiation event;
identifying an entire span of second media content to be presented in the amount of time;
partitioning the entire span of second media content into plural second media content segments, each second media content segment corresponding to a temporal sub-span of the entire span of second media content; and
presenting plural second media streams of second media content at a same time, the plural second media streams of second media content being associated with the plural second media content segments.

13. The method of claim 2, wherein said returning to the synchronized state comprises:
identifying an amount of time to reach the synchronized state, following the resynchronization-initiation event;
identifying an entire span of second media content to be presented in the amount of time;
forming the digest for the entire span of second media content, the digest corresponding to an abbreviated version of the entire span of second media content; and
presenting the stream of second media content based at least on the digest.

14. The method of claim 2, further comprising:
forming the digest by:
identifying different scenes within a span of second media content to be presented during an amount of time occurring between the resynchronization-initiation event and reaching the synchronized state; and
selecting representative video frames of the different scenes to produce the digest.

15. The method of claim 2, further comprising:
forming the digest by:
identifying low-value video frames in a span of second media content to be presented during an amount of time occurring between the resynchronization-initiation event and reaching the synchronized state, wherein the low-value video frames are assessed with respect to one or more characteristics; and
eliminating the low-value video frames from the span of second media content to produce the digest.

16. The method of claim 15, further comprising:
identifying a redundant video frame from the span of second media content as redundant with respect to at least one other video frame from the span of second media content; and
removing the redundant video frame from the span of second media content to produce the digest.

17. The method of claim 2, further comprising:
forming the digest by:
identifying high-value video frames in a span of second media content to be presented during an amount of time occurring between the resynchronization-initiation event and reaching the synchronized state, wherein the high-value portions video frames are assessed with respect to one or more characteristics; and
including at least some of the high-value video frames in the digest.

18-20. (canceled)

21. A computing device comprising:
one or more hardware processor devices; and
one or more storage resources storing machine-readable instructions which, when executed by the one or more hardware processor devices, cause the one or more hardware processor devices to:
in a synchronized state, present audio content in synchronization with video content, wherein parts of the audio content are presented concurrently with corresponding parts of the video content;
based at least on a physical location or physical orientation of a user, detect a desynchronization event that indicates that the user has diverted attention away from a display device presenting the video content;
in response to the desynchronization event, transition from the synchronized state to a desynchronized state by slowing a rate at which the video content is presented relative to the audio content while maintaining a rate at which the audio content is presented;
based at least on the physical location or the physical orientation of the user, detect a resynchronization-initiation event that indicates that the user has resumed paying attention to the display device; and
in response to the resynchronization-initiation event, return to the synchronized state by providing a compressed presentation of the video content.

22. The computing device of claim 21, wherein the machine-readable instructions, when executed by the one or more hardware processor devices, cause the one or more hardware processor devices to:
detect the desynchronization event and the resynchronization-initiation event based at least on the physical location of the user relative to the display device.

23. The computing device of claim 21, wherein the machine-readable instructions, when executed by the one or more hardware processor devices, cause the one or more hardware processor devices to:
detect the desynchronization event and the resynchronization-initiation event based at least on the physical orientation of the user's head relative to the display device.
